(19) United States
(12) Patent Application Publication
(10) Pub. No.: US 2006/0256008 A1
(43) Pub. Date: Nov. 16, 2006

(54) Pointing interface for person-to-person information exchange

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/344,612

(22) Filed: Jan. 31, 2006

Related U.S. Application Data
(63) Continuation-in-part of application No. 11/315,755, filed on Dec. 21, 2005.
(63) Continuation-in-part of application No. 11/344,701, filed on Jan. 31, 2006.
(60) Provisional application No. 60/680,699, filed on May 13, 2005.
(60) Provisional application No. 60/717,591, filed on Sep. 17, 2005.
(60) Provisional application No. 60/707,909, filed on Aug. 12, 2005.

(51) Int. Cl. H04B 7/00; G01S 5/14

(52) U.S. Cl. 342/367; 342/357.08

(57) ABSTRACT

A system for enabling a person to person communication from one portable computing device to one or more other portable computing devices based upon physically pointing a portion of one portable computing device in the direction of other portable computing devices. The portable computing devices consist of a CPU, a locative sensor system, an orientation system, and an interface to a distributed network. The distributed network sends and receives data to the portable computing devices. Connected to the distributed network is a User Tracking Application (“UTA”). The User Tracking Application receives location and orientation information from each of the portable computing devices. Based on the location and orientation of the portable computing devices and via control of the users, messages and data may be sent between the devices. The User Tracking Application also allows filtering of groups of users based on particular attributes, such as, age, gender, profession, organizational affiliation, income, etc. The system also allows for the electronic retrieval of crowd demographics. A person with a portable computing device is able to point to a crowd of individuals and information about those individuals with portable computing devices may be retrieved and compiled.

### CROSS REFERENCE TO RELATED APPLICATIONS

None

This application claims, under 35 U.S.C. §119(e), the benefit of U.S. Provisional Application No. 60/717,591, entitled POINTING INTERFACE FOR PERSON-TO-PERSON INFORMATION EXCHANGE, filed Sep. 17, 2005, (Attorney Docket No 3502.027) by Rosenberg, which is incorporated in its entirety herein by reference.

This application is a continuation in part, under 35 U.S.C. §120, of U.S. patent application Ser. No. 11/315,755 (Attorney Docket No 3502.016), entitled METHOD AND APPARATUS FOR ACCESSING SPATIALLY ASSOCIATED INFORMATION as filed Dec. 21, 2005, by Rosenberg, which also claims benefit under 35 U.S.C. §119(e) to U.S. Provisional Application No. 60/680,699, entitled DATASCOPE INTERFACE FOR ACCESSING DISTANT SPATIALLY ASSOCIATED INFORMATION, filed May 13, 2005, (Attorney Docket No 3502.015) by Rosenberg, which are incorporated in their entirety by reference.

This application is a continuation in part, under 35 U.S.C. §120, of U.S. patent application Ser. No. ______ (Attorney Docket No 3502.022), entitled TRIANGULATION METHOD AND APPARATUS FOR TARGETING AND ACCESSING SPATIALLY ASSOCIATED INFORMATION as filed ______, 2006, by Rosenberg, which also claims benefit under 35 U.S.C. §119(e) to U.S. Provisional Application No. 60/707,909, entitled METHOD AND APPARATUS FOR ACCESSING OF DISTANT SPATIALLY-ASSOCIATED INFORMATION, filed Aug. 12, 2005, (Attorney Docket No 3502.021) by Rosenberg, which are incorporated in their entirety by reference.

### FEDERALLY SPONSORED RESEARCH

None

### BACKGROUND OF THE INVENTION

1. Field of the Invention

This invention relates to person to person communication systems that use a portable computing device as a pointing mechanism to retrieve and transfer information from users of other portable computing devices.

2. Discussion of the Related Art

This invention relates generally to the field of technology in which information is stored and accessed based upon physical geographic locations. Such systems are described in the paper by Spohrer entitled Information in Places and published in IBM Systems Journal, vol. 38, No. 4, 1999 (p. 602-628) which is hereby incorporated by reference. A preferred embodiment of the present invention also relates generally to person-to-person communication such as that enabled by portable devices such as cellular phones, personal digital assistants, and other similar mobile electronic devices with communication capabilities.

Another embodiment of the present invention also relates to mobile social networking applications that track the location of a plurality of users of mobile electronic devices upon one or more servers that are accessible by one or more of said plurality of users over a communication link. More specifically, another embodiment of this invention relates to obtaining information pertaining to a particular person or group of persons based upon the then current location of that person (or group of persons) as determined by a spatial transducer on the body of that person (or persons). Even more specifically, an embodiment of the present invention relates to enabling a user to select a particular person or group of persons from among a plurality of other persons by pointing at the then current location of the particular person (or group of persons) with at least a portion of a portable computing device and thereby obtain information pertaining to that particular person or group of persons. Such information may include but is not limited to identification information, demographic information, and social networking information related to said person (or group of persons) being pointed at.

In addition, an embodiment of this invention relates to selectively initiating communication with a particular person or group of persons based upon the then current location of that person (or group of persons) as determined by a spatial transducer on the body of that person (or persons) and the ability to select said particular person or group of persons by pointing at the then current location of said person (or group of persons) and engaging a user-interface.

3. Overview of the Prior Art

A number of systems have been developed for accessing location-related information. In most such systems, the location related information is accessed by a user of a portable computing system based upon the then current location of the portable computing system as determined by one or more Global Positioning System (GPS) sensor local to a computing system.

For example, U.S. Pat. No. 6,122,520 entitled “System and method for obtaining and using location specific information” and hereby incorporated by reference, describes a system that uses Navstar Global Positioning System (GPS), in combination with a distributed network, to access location related information based upon GPS coordinates that describe the current location of a portable computing device. In addition U.S. Pat. No. 6,819,267 entitled “System and method for proximity bookmarks using GPS and pervasive computing” and hereby incorporated by reference, also describes a system for accessing location related information using GPS coordinates that describe the current location of a portable computing device. US patent application 20050032528 entitled “Geographical web browser, methods, apparatus and systems” and hereby incorporated by reference, also describes a system for accessing location related information using GPS coordinates that describe the current location of a portable computing device. A limitation with such systems is that a user may want to gain information about a location that they are not local to, but which is off in the viewable distance to that user. To address this problem, methods and apparatus have been developed by the present inventor in co-pending provisional patent applications 60/680,699 filed on May 13, 2005 and 60/707,909 filed on Aug. 12, 2005, both of which are hereby incorporated by reference, and both of which enable a user to gain information about a particular distant location by pointing at that location in space.

A problem with the current location-related information accessing systems mentioned in the paragraph above is that while they can access information related to a specific location and/or an object fixed at a specific location, they generally do not enable a user to gain information about an object that is freely mobile within an environment such as another user of a portable computing device. An embodiment of the current invention addresses this need by providing the unique methods and apparatus as described herein. Another problem with the current location-related information accessing systems described above is that they do not include methods and apparatus for enabling a user to initiate a conversation with another user by pointing at that user's spatial location. Another problem with the current location-related information accessing systems described above is that they do not include specific methods and apparatus for enabling a user to access personal demographic information about another user and/or group of users based upon their temporary location at a specific moment in time by pointing at that temporary location at that specific moment in time. An embodiment of the current invention addresses this need by providing the unique methods and apparatus as described herein

Another technology known to the current art that is related to the present invention is referred to herein as mobile social networking systems. Such applications are operated as managed services by application service providers (ASPs) and operate using several common characteristics. For example, users typically create unique personal profiles that include basic information including age, gender, user name, interests, profession, history, testimonials and information about their network. In some applications, users map their relationship with other members, either by inviting other members to join their network (e.g., Friendster or Linkedin), or by using software to scan existing relationships recorded in computer contact software (e.g., Spoke or Visible Path). Most commonly, these applications provide such functions as friend-finding, text-dating and community message aggregation. Friend-finder applications (e.g., Dodgeball) can identify the location of the user and the friend of a user and alert the user when the friend is within certain proximity. Such applications may also consult the relationship map and identify “friends of friends” who have announced they are within a certain range of the user's vicinity. Text-dating applications (e.g., MobiVibe) allow users to connect with new friends who meet age and gender criteria, enabling users to communicate, e.g., to exchange text messages. Community message aggregators (e.g., Upoc) distribute messages from one member to all members within a specific community. A system disclosed in pending U.S. Patent Application 20050177614, which is hereby incorporated by reference, enables like-minded mobile device users to meet one another, on a permission basis, based upon one or more factors, such as: each user's reciprocal networking objective, the nature of the industry in which the user works, the user's level within the management hierarchy of his or her company, any specialty function the individual may possess, and soon.

A problem with the current mobile social networking systems mentioned above is that they do not allow a user to gain information about or initiate communication with a target user (or target group of users) by simply pointing at the then current location of that target user (or target group of users). The pointing method is highly convenient and intuitive for users and provides a significant advantage over other more cumbersome and time-consuming methods, such as dialing a phone number, typing in an email-address, or entering a particular coordinate or identifier. In addition it allows a user to communicate with or gain information about other users when that user does not have identifying information about the other users other than their current spatial location as viewed by the user. In other words, a user may see another person in the distance and may not know anything about that person other than what he or she currently sees. The user may desire to gain information about that person and initiate communication with that person and needs a convenient and intuitive way to do so. An embodiment of the current invention addresses these and other needs by providing the unique methods and apparatus as described herein.

### SUMMARY OF THE INVENTION

A system for pointing-initiated person to person communication, the communication system comprising a first portable computing device operated by a first user, said first portable computing device including a first location sensor, an orientation sensor; an user aiming portion, and a first wireless communication link to an user tracking application. A plurality of second portable computing devices, the second portable computing devices each including a second location sensor and a second wireless communication link to the user tracking application. Software routines running upon the user tracking application for determining if the aiming portion of said first portable computing device is aimed substantially in the direction of the second portable computing devices as indicated by the first location sensor and orientation sensor as communicated over the first wireless communication link; and the spatial location of said second portable computing device as indicated by the said second location sensor as received by the second portable computing device over the second wireless communication link. Also software routines running upon the user tracking application for enabling person to person communication between the user of the first portable computing device and each of the separate users of the second portable computing devices in response to said determination.

The method of providing person to person communication comprising determining the location and the pointing orientation of a first portable computing device proximately located to a first user; determining the locations of a plurality of second portable computing devices proximately located to each of the second users in the pathway of the pointed orientation of the first portable computing device; communicating a message from the first user of the first portable computing device to the plurality of second users operating the second portable computing devices.

Also a method for targeting the user of a portable computing device comprising the determination of the location of a plurality of portable computing devices on a periodic basis; storing the individual locations of each portable computing device and creating a historical record; computing the direction and velocity of each portable computing device based; and estimating the future location of a portable computing device based on the prior historical locations of the user.

### BRIEF DESCRIPTION OF THE DRAWINGS

Preferred embodiments of the invention will be described in conjunction with the following drawings, in which:

FIG. 1 illustrates how mobile device users register to use the business networking service of the present invention.

FIG. 2 shows one embodiment of a portable computing device configured consistent with the current invention as a portable telephone with user targeting capabilities.

FIG. 3 illustrates a pair of mobile device users engaged in the person-to-person pointing-based communication and information access.

FIG. 4 shows one embodiment of this invention that employs a laser based targeting tool.

FIG. 5a shows how a targeting vector is defined with respect to the current positional coordinates of a targeting user and a targeted user.

FIG. 5b shows how a user locative vector is defined with respect to the current positional coordinates of a targeting user and a targeted user.

FIG. 5c and FIG. 5d shows how a targeted user can be presented with information that indicates the direction from which a targeting user has targeted him.

FIG. 6 shows a portable computing device equipped with a GPS sensor for tracking its position and one or more orientation sensors for tracking the direction it is aimed by a user. Also shown is an integrated digital video camera for capturing a line-of-sight image in the direction that the user aims the portable computing device.

FIG. 7 shows a portable computing device operative to perform certain methods disclosed herein for selecting a target user from among a plurality of distant users.

FIG. 8 shows a portable computing device operative to perform s two step targeting process in which a user defines the bounding edges of a target region as a means of targeting a group of users.

### DETAILED DESCRIPTION

Overview of User Tracking Applications

A business or social networking application is running on a server or a group of servers. The application, which is operative to keep track of the current geographic location of a plurality of users, each user using a portable computing device such as a cell phone or PDA or other mobile computing device, is referred to herein as a user tracking application (hereinafter “UTA”). The server or group of servers that runs the UTA is referred to herein as the “UTA server”. By current geographic location it is understood that there will generally be some amount time lag that causes the most current location stored for some or all users to reflect that user's location at a recent time in the past. It is therefore desirable for an embodiment of current invention to keep such time lags as small as possible within the practical limitations of the technology employed. It is also generally desirable for an embodiment of the current invention to store a time-history of current geographic locations for said plurality of users, said time-history reflecting one or more previous but recent locations of each of said plurality of users. Furthermore, in some embodiments of the present invention the UTA application running on the UTA server may be operative to predict a current location of a user based at least in part upon the stored time-history of previous locations of that user. Furthermore, in some embodiments of the present invention the UTA application running on the UTA Server may be operative to predict a current location of a user based in part upon a velocity derived from the stored time-history of previous locations of that user. Furthermore, in some embodiments of the present invention the UTA application running on the UTA server may be operative to predict a current location of a user based in part upon velocity data received for that user over a communication link

In addition to tracking the current location of a plurality of users, each using a portable computing device, the UTA application as disclosed herein may also be operative to store a unique personal profiles for each of said plurality of users, the unique personal profile including personal information such as the age, gender, name, interests, profession, political affiliations, organizational affiliations, school affiliations, team affiliations, job title, marital status, sexual orientation, height, weight, highest level of education, IQ, music preferences, sports team preferences, dietary preferences, hobbies, income, and/or fitness level for each user. The UTA application may also be operative to store information about each user's friends or business associates in their social network, maintaining a map or other storage of their personal relationships with other users. Such information, whether it is personal or business related, is referred to herein as social networking information.

The UTA application may also be operative to store access-preference information for each user, the access-preference information describing or limiting how other users may gain information about or initiate communication with that user. For example, access-preference information may limit access to some or all of the personal information for a particular user only to other users who match certain criteria, possess certain characteristics, or meet certain security requirements. Similarly, access-preference information may limit communication with a particular user only to other users who match certain criteria, possess certain characteristics, or meet certain security requirements.

In some embodiments said certain security requirements includes a particular user possessing a password or satisfying some other authentication. In some embodiments said certain criteria includes a particular user being a member of a particular network of friends or business associates. In some embodiments said certain characteristics includes a particular user having a certain combination of demographic characteristics. The personal information stored for each user on the UTA server may be indexed by a users name, social security number, biometric sample, or other commonly known personal identifier. Such personal information may alternatively be indexed by a server specific identifier that does not include a user's name, social security number, or other widely known personal identifier. In this way a user may maintain a personal profile the UTA server with substantial personal information but still remain substantially anonymous.

Many users access the UTA server, each of the users using a portable computing device with wireless network capability and spatial location tracking using a GPS transducers or other position orientation determining components.

The methods and apparatus as disclosed herein enable the portable computing device user to access information about one another or initiate communication with one another, based in whole or in part by targeting a group of users by pointing at least a portion of his portable computing device at the current physical location at the group users. The methods and apparatus as disclosed herein also enable one of the users to access information about a group of users or initiate communication with many of the other users by pointing at least a portion of his or her mobile computing device at the current physical location of group of users. The pointing at the current physical location at the group of other users may include the step of defining a range of locations or a sequence of locations at which or between which group of other users are then currently located.

User Tracking Application Person to Person Communications Control

The determination of whether a user accesses information about another user depends upon the first user targeting the second user by pointing his or her mobile computing device at the second user.

The determination of whether the first user accesses information about the second user and the extent of the information that the first user may access, may also be dependent upon: (1) privacy and/or security parameters established by said second user and optionally stored as access-preference information for that user upon the UTA server; (2) personal profile parameters and/or identification parameters established by said first user and optionally stored as personal profile information for that user upon the UTA server; or (3) social networking data associated with the first user or second user and optionally stored as social networking information for those users upon the UTA server.

The determination of whether the first user accesses information about the second user or the extent of the information that said first user may access, may also be dependent upon one or more specific demographic traits associated with the first user or the second user, the personal demographic traits including but not limited to data reflecting the age, gender, occupation, sexual orientation, height, weight, income, IQ, highest level of education, political party, personal interests, group memberships, school affiliations, company affiliations, team affiliations, job title, level of corporate hierarchy, and/or marital status of that user, or any combination of the aforementioned. The determination of whether the first user may access information about the second user may also be dependent upon the second user providing user input through the user interface of his portable computing device to explicitly authorize information access when an information access attempt is made by the first user.

Similarly, the determination of whether a first user initiates communication with the second user depends upon the first user targeting the second user by pointing at least a portion of his or her mobile computing device at the current physical location of said second user. The determination of whether said first user initiates communication with said second user may also be dependent upon: (1) privacy and/or security parameters established by said second user and optionally stored as access-preference information for that user upon the UTA server, (2) personal profile parameters and/or identification parameters established by the first user and optionally stored as personal profile information for that user upon the UTA server, or (3) social networking data associated with the first user and/or second user and optionally stored as social networking information for those users upon the UTA server. The determination of whether said first user initiates communication with the second user may also be dependent upon one or more specific personal demographic traits associated with the first or second user, said personal demographic traits including but not limited to data reflecting the age, gender, occupation, sexual orientation, height, weight, income, IQ, highest level of education, political party, personal interests, group memberships, school affiliations, company affiliations, team affiliations, job title, level of corporate hierarchy, or marital status of that user, and any combination of the aforementioned. The determination of whether the first user may initiate communication with the second user may also be dependent upon said second user providing user input through the user interface of his or her portable computing device to explicitly authorize communication when a communication initiation attempt is made by said first user.

Embodiments of the present invention may be implemented as a computer system that facilitates business or social networking activities by and among portable computing device users. In one embodiment, portable computing device users use a Web browser (on a computer, or the portable device itself) to register online for a managed networking service that is provided by a system operator who administers the system and manages information accesses and communication initiations between registered portable computing device users. In particular, the system operator runs at least one UTA server that tracks the locations of a plurality of active portable computing device users and programmatically identifies based upon received data and computation, when one of the portable computing device users targets another of said portable computing device users. The server also maintains data about the users to regulate information access or communication initiation, the data optionally including personal profile information, access-preference information, or social networking information. The information may be supplied by (or derived from) the respective portable computing device users during the registration process or during subsequent interactions with the UTA server. The information may include, but is not limited to, personal identification information, personal accessibility preferences, personal password information, and/or personal demographic information that may include but is not limited to the user's stated age, gender, occupation, sexual orientation, height, weight, income, IQ, highest level of education, political party, personal interests, group memberships, school affiliations, company affiliations, team affiliations, job title, level of corporate hierarchy, and/or marital status. The profile data may also include a list of access preferences that describes or lists user qualities or user demographic or social networking characteristics that may be granted access to information or authorized to initiate conversation with said user. An example registration process is disclosed in pending U.S. Patent Application 20050177614 which is hereby incorporated by reference.

In some embodiments of the present invention the UTA server maintains data about each of the users that reflect their performance in the user to user interactions moderated by the server. For example, the UTA server may maintain and store peer-rating information about each user, the peer-rating information is data about each user that has been compiled based upon input from other users as a result of previous interactions between that user and other users as moderated by the UTA server. This information reflects the satisfaction or dissatisfaction that other users expressed as a result of such previous interactions with that user. A user who achieves a high satisfaction level within his or her peer-rating information is likely to be a socially well-behaved person who acts appropriately when accessing information or initiating communication with other users. A user who achieves a low satisfaction level within his or her peer-rating information is likely to be a socially poorly-behaved person who acts inappropriately when accessing information or initiating communication with other users.

Similarly, the UTA server may maintain and store user popularity information about each user, the user-popularity information is data about the a user that has been compiled based upon the number of previous interactions between that user and other users as moderated by the UTA server. This information reflects the number of times that user has had other unique users access information about him or her and/or the number of times that user has had other unique users initiate communication with him or her. In this way the data reflects how popular a given user is among other users. For example, a user who has had information accessed about him or her often by unique (different) users or has had communication initiated with him or her often by unique (different users) is more likely to be more popular than a user who has not had as many other unique users express interest or make such inquiries.

The UTA server interfaces to a telecommunications network through a gateway, such as a message gateway. As noted above, whether a first registered portable computing device user is enabled to gain information about or initiate communication with a second registered portable computing device user typically depends on several factors. One of the factors is the first user successfully targets the second user by pointing at his current physical location. Other factors are based upon personal profile information, access-preference information, or social networking information stored for the first user and the second user. Other factors may also include the second user authorizing information access or communication initiation by responding in real-time to a prompt displayed upon his portable computing device. The prompt to the second user may include a visual, audio, or tactile alarm imparted by the second user's portable computing device to get the second user's attention as well as a visual or audio prompt indicating that another user has requested information access or requested communication initiation. The prompt may provide the first user's name, ID, handle, or other identifier. The prompt may also provide the second user with demographic information and/or social networking information about the first user. The prompt may also provide the second user with spatial information about the location of the first user relative to the second user. For example, a graphical map may be displayed that indicates the relative location of the first user with respect to the second user, depicting the relative distance and direction in which the first user currently resides.

Whether a first registered portable computing device user is enabled to gain information about or initiate communication with a second registered portable computing device user typically also depends upon whether said second registered portable device user has configured his status parameters to an “active” setting. When “active”, a user has informed the UTA server to track his or her location and consider requests from other users for information access or communication initiation. When “inactive,” a user has informed the UTA server not to track his or her location and/or not to consider requests from other users for information access and/or communication initiation. In this way a user can easily maintain his or her privacy by setting a status parameter to inactive when privacy is desired. In some embodiments of the present invention additional temporary settings are enabled beyond active and inactive, said additional settings regulating the degree of information access and/or communication initiation that is enabled at any given time. In many embodiment said additional settings are enabled as temporary adjustments to the access preference information for that user. For example, temporary access setting is “close friends only” in which case the UTA server is configured for a particular user to only allow information access and/or communication initiation from others who are indicated as “close friends” of that particular user in the social networking information for that user. Similarly, another temporary access setting is “coworkers only” in which case the UTA server is configured for a particular user to only allow information access and/or communication initiation from others who are indicated as “coworkers” of that particular user in the social networking information for that user. Similarly, a user attending a ball game may choose a temporary access setting of “Giant's fans only,” only allowing information access and/or communication initiation from others who are indicated as “Giant fans” in the personal profile information data for those other users. By using such temporary access-preference settings, a user can selectively regulate any given time which users may and which users may not access information about that user or initiate communication with that user based upon the personal demographic information for those users, social networking information for those users, or any combination thereof. Likewise, a user may configure his or her temporary access-preference settings such that only users who are between 21 and 29 years old and who are giant's fans may access information about that user or initiate communication with that user using the methods and apparatus of an embodiment of present invention.

As mentioned above, the current an embodiment of the current invention enables a first user of a first portable computing device to access information about or initiate communication with a second user of a second portable computing device by physically pointing the first portable computing device at the location of the second user. To enable this inventive functionality, the present embodiment employs a plurality of portable computing devices, each equipped with a positioning system such as a GPS transducer interfaced with a Navistar Global Positioning System (GPS) and each having wireless access to UTA server running UTA software. In addition each portable computing device includes an orientation sensing system which may or may not employ GPS transducers. In one common embodiment each portable computing device includes a magnetometer for orientation sensing, the magnetometer used alone or in combination with other sensors such as GPS sensors or accelerometer sensors for detecting the current orientation of the portable computing device with which it is associated. Communication between each portable computing device and the UTA server is generally enabled through a wireless transceiver connected or integrated within each of the plurality of portable computing devices.

The GPS transducer or other position and orientation transducers associated with each portable computing device are operative to generate a coordinate entry that relates to the then current position and orientation of that portable computing device, the coordinate entry and/or a representation thereof is communicated over the wireless communication link to the UTA server running the UTA software along with identifying information that indicates from which portable computing device the coordinate entry was received. In this way the UTA server running the UTA software receives coordinate information representing the then current location of each of a plurality of user's using their own portable computing device. In some embodiments each portable computing device has a unique ID associated with it such that when coordinate data is transmitted to the UTA server it is sent along with the unique ID such that the UTA server can track by means of the unique ID which portable computing device among the plurality of portable computing devices having access to the UTA server the coordinate data is associated. In some embodiments each user of a portable computing device has a unique ID associated with that user such that when coordinate data is transmitted to the UTA server it is sent along with the unique ID such that the UTA server can track by means of the unique ID which user among the plurality of users who are members of the UTA server system the coordinate data is associated. In some embodiments of the present invention the coordinate data generally includes only positional information, except when a user is performing a targeting operation, in which case the coordinate data also includes orientation information.

An important aspect of the present system is the inventive user targeting method by which a first user of a first portable computing device can selectively access information about and initiate communication with a second user of a second portable computing device by physically pointing the first portable computing device (or a portion thereof) at the currently viewed location of the second user which is some distance away from the first user. Another important aspect of the present system is the inventive group targeting method by which a first user of a first portable computing device can selectively access information about and/or initiate communication with a group of other user of other portable computing devices by physically pointing the first portable computing device (or a portion thereof) at the currently viewed location of the group of other users.

These targeting methods produce a targeting vector, targeting coordinate, or a group of targeting coordinates that represent the location or locations at which the first user is aiming when performing a targeting function. These targeting vector, targeting coordinate, or group of targeting coordinates are then transmitted as data to the UTA server, either directly or as a coded representation. The UTA server then uses the targeting vector, targeting coordinate, or plurality of targeting coordinates along with the then current location of the first user to determine based upon the stored location tracking information for a group of other users which of the other user or users the first user is most likely targeting. Such user(s) are referred to herein as targeted users. Once it is determined which user or users the first user is most likely targeting, the targeted users, the UTA server retrieves access preference information or personal profile information or social networking information for the targeted user(s) along with access preference information and/or personal profile information and/or social networking information for the first user. The UTA server then determines if the first user is authorized to access information about or initiate communication with one or more of the targeted users. If the first user had requested information about a targeted user and is determined to have access to that information, the information is transmitted by the UTA server to the portable computing device of the first user. The information is then displayed to the first user by the visual or audio display features of the portable computing device. If the first user had requested communication with a targeted user and is determined to have communication initiation access authorization with that targeted user, the UTA server enables communication from the first user to the targeted user. This may be achieved by the UTA server routing a communication message or communication request from the first user to the targeted user. Alternately this may be achieved by sending communication authorization data or communication routing data to the first user enabling the first user to communicate directly with the second user without being routed through the UTA server. In some embodiments this is achieved in whole or in part by the UTA server sending a phone number, email address, instant messaging address, alias, or other similar identifier about the targeted user to the first user so that the first user can initiate communication with the targeted user.

Operation of Targeting Methods

The targeting methods as disclosed herein operate in four basic operational steps. In the first step, the transmission of positional data from each of a plurality of portable computing devices to the UTA server, the positional data representing the current geographic location of each of the portable computing devices. This step is repeatedly performed at a rapid rate such that the UTA server receives repeatedly updated and substantially current data about the location of the plurality of portable computing devices. The location information, preferably spatial coordinates such as GPS coordinates of high resolution and accuracy, are stored in a tracking database by the UTA server. The tracking database may also store a history of the location information for each of the plurality of portable computing devices. The tracking database may also include predictive location information for some or all of said plurality of portable computing devices, the predictive location information representing an anticipated location coordinate for a portable computing device as determined from current or historical location information or from velocity information for a portable computing device. Although there are many way it may be maintained, the tracking database includes substantially current information that represents the location of each of a plurality of portable computing devices based substantially upon positional data received by the UTA server over a communication link.

The second, third, and forth operational steps of the present embodiment are related to the specific targeting operation performed by a first user when seeking to gain information about or initiate communication with one or more other users. These steps are generally performed in response to the first user initiating a targeting sequence by aiming his portable computing device (or a portion thereof) at the then current visible location of one or more other users within his physical space and engaging a user interface option upon his or her portable computing device.

The second step is the reading of position and orientation sensors local to a portable computing device of the first user, the position and orientation sensors including for example a GPS sensor and other orientation sensors such as an accelerometer or magnetometer to be described in more detail later. The reading of the sensors provides a positional coordinate and orientation direction for the portable computing device as positioned by the user. In one preferred embodiment the portable computing device is a handheld unit that can be freely aimed by the user at a target remote location in space. A variety of aiming tools and methods may be employed such as a laser pointer or a displayed image from a digital camera with overlaid crosshairs as to be described in more detail later. When the portable computing device is aimed at a target user or a group of targeted users, the user presses a button, performs a gesture, utters a word or phrase, or otherwise indicates to the local system that the device is aimed at one or more targeted users. Based upon said button press or other indication by the user that the device is aimed as desired, the software running upon the portable computing device reads said position and orientation sensors to determine current positional coordinates and current orientation vector for said portable computing device.

The third step is the determination of targeting vector(s), targeting distance(s) and/or target coordinate(s) for a specific target user or group of target users as defined by the aiming of the portable computing device by the first user. The targeting itself is likely performed by the first user using one or more inventive targeting tools or targeting methods. A targeting vector is determined as an angular vector originating at the current positional coordinates of the first user and pointing in the direction that the portable computing device was aimed during targeting. A targeting distance is determined as a distance away from the current positional coordinates of the first user that a target user is positioned. A targeting coordinate is a spatial coordinate representing the targeted location of a target user as determined by adding an offset to the current positional coordinates of the first user, the offset being in a direction defined by a targeting vector and of a distance defined by a targeting distance. In some embodiments of the present invention, one or more range values is also determined for each targeting operation, the range values including one or more of an angular range value or a distance range value. An angular range value defines a range of acceptable angles around a targeting vector, for example ±5 degrees, within which a targeted user may reside. A distance range value is a range of acceptable distances around a targeting coordinate, for example ±10 feet, within which a targeted user may reside. In some embodiments a plurality of range values may be computed for a plurality of different directions, including for example a minimum value and a maximum value. Finally it should be noted that a plurality of targeting vectors, targeting distances or target coordinates may be determined during a particular targeting operation if a plurality of users are identified by the first user.

The fourth step is a determination by the UTA server based upon the targeting vector(s), targeting distance(s) or target coordinate(s), which users are being targeted and whether or not the first user can access information about the targeted user(s) or initiate communication with the targeted user(s). The forth step has a number of sub-steps.

In sub-step (A) of the fourth step, the UTA server identifies each of the targeted user(s) based upon their current geographic location as stored within the tracking database.

In sub-step (B) of the fourth step, the UTA server accesses information about each of the target users, the information including for example personal profile information, social networking information, and/or access preference information. The UTA server also accesses information about the first user, the information including for example personal profile information, social networking information, and/or access preference information.

In sub-step (C) of the fourth step, the UTA server determines based upon the information accessed in sub-step(B) whether or not the first user is authorized to access information about one or more of the targeted users and/or whether or not the first user is authorized to initiate communication with one or more of the targeted users. This determination may also be dependent upon whether or not the first user requested information about one or more targeted users, requested communication initiation with one or more targeted users, or both. This determination may also be dependent upon one or more targeted users granting permission. This determination may also be dependent upon peer-rating data or user popularity data collected for one or more of the users.

In sub-step (D) of the fourth step, the first user is given access to information and/or enabled to initiate communication with any authorized targeted users through the moderating processes of the UTA server. For example, the authorized information is accessed by the UTA server and transmitted to the portable computing device of the first user over a communication link. Similarly, if it is determined that the first user is authorized to initiate communication with one or more targeted users, the UTA server enables communication initiation with the one or more targeted users.

Description of the Portable Computing Device

As disclosed herein each portable computing device comprises a portable computer with communication capabilities or similar processor driven portable device including but not limited to a cell phone, personal digital assistant (PDA), portable media player, or processor enabled wristwatch.

The portable computer or other processor driven portable device includes a targeting apparatus or methods such that it can be aimed at a distant person (or group of persons) by the user while interacting with a interface upon the portable computing device to indicate when a desired distant person (or group of persons) is aimed. The portable computer or other processor driven portable device may also includes ranging apparatus or methods such that when it is aimed at a distant person (or group of persons), the distance to that target can be determined, estimated, or bounded.

The portable computer or other processor driven portable device also includes a wireless connection to a computational network such as the Internet and is connected to a local positional and orientation sensing system including for example a GPS sensor and preferably other sensors such as an accelerometer or magnetometer. When the portable computer or other processor driven portable device is aimed at a distant target, signals from the sensors are used to determine current positional coordinates and a current orientation vector for said portable device. The targeting apparatus is used to support the aiming process. The ranging apparatus or methods is used to derive, estimate, or bound a distance to said distant target or a range of distances to said distant target or a range of aiming angles to said distant target. Said targeting and ranging apparatus may include automatic apparatus as well as user controlled apparatus, individually or combined. For example the targeting and ranging apparatus of the embodiments may include ultrasonic ranging, optical scopes, sensed optical focusing mechanisms, digital cameras, laser pointing, laser range-finding, and triangulation hardware and software. Regardless of the targeting or ranging apparatus used, the targeting and ranging information is used by the UTA server to determine the most likely other users being targeted by a first user at a particular point in time.

Some inventive embodiments of the present invention do not include ranging apparatus to save cost and complexity. In such embodiments the user can target a distant person (or group of persons) by pointing his or her portable computing device (or a portion thereof) at the desired target location, thereby generating a targeting vector but not generating a targeting distance for without ranging apparatus or ranging methods, the targeting distance is unknown.

In such embodiments of the present invention, the UTA server receives only a current positional coordinate of the targeting user and a targeting vector indicating the direction in which that user is aiming at some other user(s). An inventive method is then followed in which the UTA server identifies the nearest other user to the targeting user along the direction of the targeting vector. In this way, the user can aim at a particular user (or group of users) and so long as they are the nearest users to him or her along the line of sight vector defined by the targeting direction, the UTA server will select that particular user (or group of users) as the targeted user(s). Thus a highly effective targeting system can be enabled without specific ranging methods of apparatus that define the exact coordinate of a desired distant user, thereby saving cost and complexity and not significantly reducing effectiveness.

In some embodiments a low-cost ranging method and apparatus is included within or upon or connected to the portable computing device that allows a user to indicate where upon the targeting vector a desired person (or group of persons) resides. The method and apparatus includes a knob, slider, roller, lever, trigger, button, graphical slider, or other manual control that allows the user to define through a manual motion or gesture specific or approximate distance to the targeted remote user(s).

In other embodiments said ranging methods or technologies are automatically controlled, including for example an ultrasonic ranging sensor that automatically detects the line-of-sight distance to a targeted remote user(s), the distance being derived as either a single distance or a range of distances.

In other embodiments said ranging methods or technologies include a laser range finder that automatically detects the line-of-sight distance to an object at said specific remote user(s), said distance being derived as either a single distance or a range of distances.

In other embodiments said targeting and ranging methods or technologies includes an optical viewing lens aimed at the specific remote location, said optical lens optionally including crosshairs overlaid upon the users view of the specific remote user(s).

In other embodiments the targeting and ranging methods or technologies includes a digital video camera that is aimed by the user at said specific remote user(s), an image from said video camera being displayed to said user upon a display on said portable computing device such that the user can see what is being aimed at and thereby target said specific remote user(s).

In some embodiments the image displayed upon said portable computing device includes an overlaid cross-hairs or other graphical indicator that demarks the particular user being aimed at (or group of users).

In some embodiments the ranging methods or technologies include a pair of cameras that capture a pair of images, the differences in the pair of images being used to derive a distance to a user or group of users.

In some embodiments the targeting methods or technology include a laser pointer that can be aimed by the user at the specific user (or group of users). Such embodiments use an eye-safe laser for the protection of the users being aimed at.

Positional and Orientation Sensing:

To determine the spatial position of each portable computing device of the embodiment of the present invention, each portable computing device includes GPS sensor or other positional sensing system. To determine the spatial orientation of each portable computing device of the present embodiment, additional specialized sensors for orientation sensing such as accelerometer sensors, tilt sensors, magnetometer sensors are included.

In preferred embodiments, the portable computing device includes a radio frequency (RF) transceiver for accessing a remote network. It should be noted that other bi-directional communication links can be used other than or in addition to RF.

Overview of the Drawings

The preferred embodiment of the present invention enables portable computing device users to engage in person to person communication or information access through a process that involves targeting other users by pointing a portion of their portable computing device at the physical location of those other users.

As used herein, “portable computing device” should be broadly construed as including any mobile wireless client device, e.g., a cell phone, pager, a personal digital assistant (PDA, e.g., with GPRS NIC), a mobile computer with a smartphone client, or the like. A typical portable computing device is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex. The portable computing device operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks.

In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. The preferred embodiment is not limited to mobile device users who have WAP-enabled devices or to use of any particular type of wireless network. Such devices and networks are merely illustrative; any wireless data communication technology now known or hereafter developed may be used in connection with the embodiments that are now described in more detail

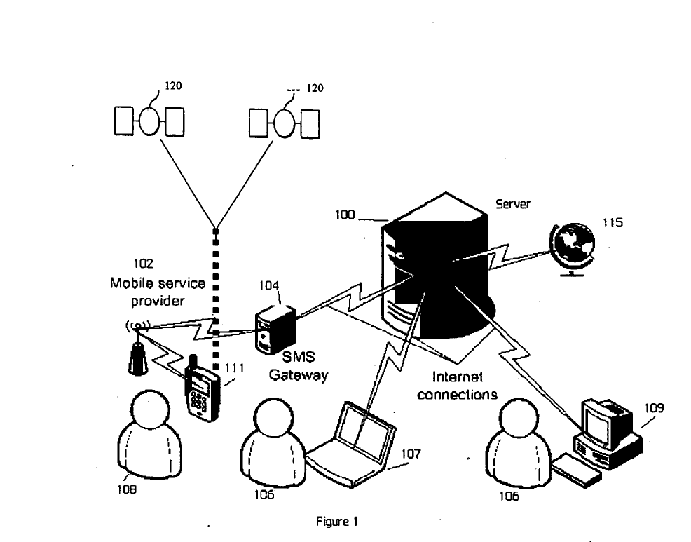

As illustrated in FIG. 1, the present invention may be implemented as a managed service (e.g., in an ASP model) using a UTA server 100, which is connected or connectable to one or more networks. For illustrated purposes, the UTA server 100 is illustrated as a single machine, but one of ordinary skill will appreciate that this is not a limitation of this embodiment. More generally, the service is provided by an operator using a set of one or more computing-related entities (systems, machines, processes, programs, libraries, functions, or the like) that together facilitate or provide the inventive functionality described below. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-routable Internet, a corporate intranet, a private network, or any combination thereof, depending on the desired implementation environment. As illustrated FIG. 1, the UTA server 100 is also in communication with a mobile service provider (MSP) 102 through a gateway, such as SMS gateway 104.

As also illustrated in FIG. 1, one or more users 106 register for the service, typically by using a client machine which may be the portable computing device 111 or some other machines such as a laptop 107 or desktop computer 109. When a desktop computer is used, registration is initiated by an end user opening a Web browser to the operator's Web site registration page (or set of registration pages). When a portable computing device is used, registration may be initiating through a mini-browser or other similar interface. These techniques are merely representative, as any convenient technique (including, without limitation, email, filling out and mailing forms, and the like) may be used. Thus, in the illustrated embodiment, users register with the UTA server 100 (or set of servers) either through Internet connections from personal computers, or via remote registration through a mobile device.

Also illustrated in FIG. 1 is a Global Positioning System (GPS) 120 for use in tracking the location of portable computing devices such as device 111. Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to this embodiment. However, other positioning systems are also contemplated for use with the present invention.

In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In order to gain orientation information, one or more sensors may be included within or affixed to the portable computing device. Some sensors can provide tilt information with respect to the gravitational up-down direction. Other sensors can provide orientation information with respect to magnetic north. For example an accelerometer may be included to provide tilt orientation information about the portable computing device in one or two axes. In some embodiment a single axis accelerometer is used that senses the pitch angle (tilt away from horizontal) that the portable computing device is pointing. In other embodiments a 2-axis accelerometer can be used that senses the pitch angle (tilt away from horizontal) that the portable computing device is pointing as well as the roll angle (left-right tilt) that the portable computing device is pointing. A suitable accelerometer is model number ADXL202 manufactured by Analog Devices, Inc. of Norwood Mass. To sense the orientation of the portable computing device with respect to magnetic north, a magnetometer is included. In one embodiment a 3-axis magnetometer model number HMC1023 manufactured by Honeywell SSEC of Plymouth, Mass. is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the portable computing device. All of the orientation sensor may all be housed within the casing of the portable computing device and be connected electronically to the microprocessor of the portable computing device such that the microprocessor can access sensor readings and perform computations based upon and contingent upon said sensor readings.

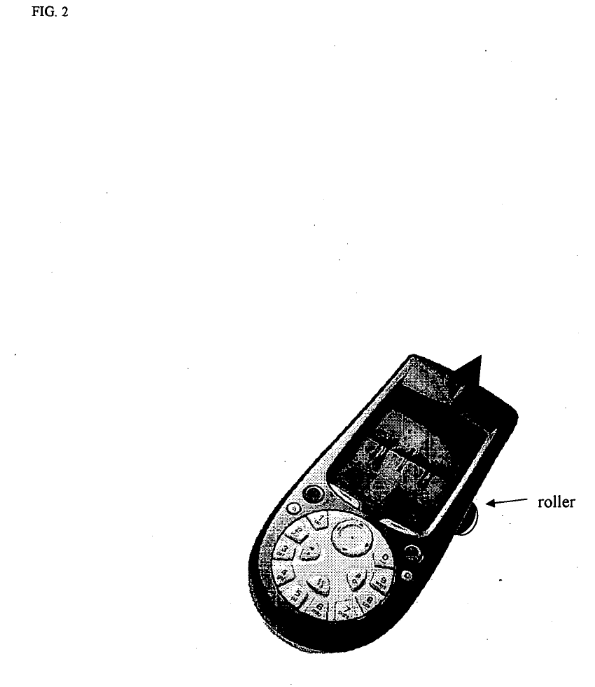

As illustrated in FIG. 2, a portable computing device configured with appropriate hardware and software. As shown in the FIG. 2, the portable computing device includes basic telephone features such as a dial pad and a handset configuration with microphone and speaker. The portable computing device includes a computer processor, an information display, a user interface, and a wireless communication link to an information network such as the Internet. The portable computing device also includes a differential GPS transceiver for sensing the geographic location of the portable computing device with a high degree of accuracy. The portable computing device also includes one or more orientation sensors such as a magnetometer for sensing geometric orientation with respect to geographic north and an accelerometer for sensing pitch angle of the device with respect to the gravitational horizontal when aimed at another user. Also the portable computing device is shaped such that it can be conveniently pointed at one or more other users by the user. Also the portable computing device includes or more targeting and ranging methods or technologies for targeting one or more other users when aimed by the user. For example the portable computing device may include an optical lens, a laser pointer, an ultrasonic sensor, a laser rangefinder, a digital camera, and a pair of stereo digital cameras. The portable computing device also includes a user interface component such as a button, knob, switch, lever, or trigger that the user manipulates so as to indicate that the portable computing device is then currently aimed at a desired target user.

The portable computing device also includes a GPS receiver and a radio transmitter/receiver, e.g., transceiver, and one or more orientation sensors such as a magnetometer (not shown) and an accelerometer (not shown). The GPS receiver receives signals from three or more GPS transmitters and converts the signals to a specific latitude and longitude (and in some cases altitude) coordinate as described above. The GPS receiver provides the coordinate to the software running upon portable computing device. The orientation sensors provide orientation data to software running upon the portable computing device, said orientation data indicating the direction at which the portable computing device is pointing when aimed at another user (or group of users) by the user. Additional ranging technology may be included (not shown), said ranging technology used by the user to determine, estimate, or indicate the line-of-sight distance or a range of distances to targeted user(s).

The user of the portable computing device aims the device at another user using one or more targeting methods and technologies. For example, a targeting device such as digital camera or integrated laser pointer may be used. Also, optionally included are automatic ranging hardware such as an ultrasonic sensor or laser rangefinder. The user aims the targeting device at a desired distant user (or group of users) and presses a button (or other user interface) upon the portable computing device to indicate that the device is currently aimed.

The software running upon the portable computing device then computes a targeting vector, targeting coordinate, or targeting distance for the targeted user (or group of users). The targeting vector is derived in whole or in part using the magnetometer which gives an orientation vector with respect to magnetic north. The direction may also include a pitch angle with respect to the gravitational horizontal. This pitch angle can be derived from the sensor data collected from an on board accelerometer (or other tilt sensor). The targeting distance is derived in one of a number of ways. It can be estimated by the user controlling a user interface such as a ranging knob or slider. It can be computed using a ranging sensor such as an ultrasonic transducer or a laser rangefinder.

The distance magnitude can be a single value or a range of acceptable values as specified by the user. The targeting and/or ranging information along with the current positional coordinate of the user are transmitted to the UTA server over the wireless communication link when a targeting operation is performed.

The UTA server uses this information to identify the targeted user(s) based upon location information of current users stored in a tracking database. Once the targeted users(s) are identified by the UTA server, information is accessed by the server about the user(s), the information including personal profile information, social networking information, and/or access preference information. In addition information is accessed about the targeting user, the information including personal profile information, social networking information, and/or access preference information.

The UTA server then determines based upon the information if the targeting user is authorized to access information about and initiate communication with one or more of the targeted users. If the targeting user had requested information about a targeted user and is determined to have access to that information, the information is transmitted by the UTA server to the portable computing device of the targeting user. The information is then displayed to the targeting user by the visual or audio display features of the portable computing device. If the targeting user had requested communication with a targeted user and is determined to have communication initiation access authorization with that targeted user, the UTA server enables communication from the targeting user to the targeted user. This may be achieved by the UTA server routing a communication message or communication request from the targeting user to the targeted user. Alternately this may be achieved by sending communication authorization data or communication routing data to the targeting user enabling the targeting user to communicate directly with the second user without being routed through the UTA server. In some embodiments this is achieved in whole or in part by the UTA server sending a phone number, email address, instant messaging address, alias, or other similar identifier about the targeted user to the targeting user so that the targeting user can initiate communication with the targeted user. The specific process by which the UTA server determines if the targeting user is authorized to gain information about or initiate communication with one or more targeted users will be described in more detail to follow.

Because a user may wish to target a particular parson in an environment filled with a plurality of persons and because GPS and other sensors have limited accuracy and resolution, an important aspect of the this embodiment is the ability to target distant user(s) that are within certain proximity of a targeting vector or targeting coordinate. This is achieved by defining or otherwise specifying an angular range around a targeting vector or a distance range around a targeting coordinate within the limits of which a targeted user will be identified by the UTA server. In this way targeting accuracy limitations can be accommodated for. In some preferred embodiments the user can set the angular range values or distance range values by accessing a menu driven interface upon the portable computing device.

In another embodiment of the present invention enables users of a portable computing device to engage in person to person communication or information access through an inventive process that involves targeting other users by pointing a portion of their portable computing device at the physical location of those other users.

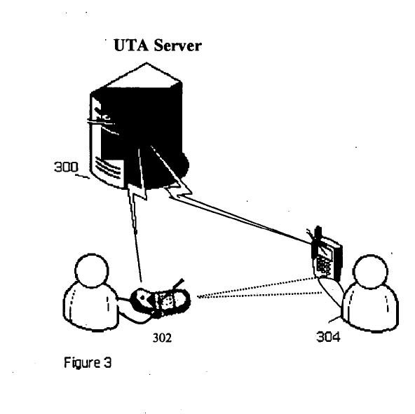

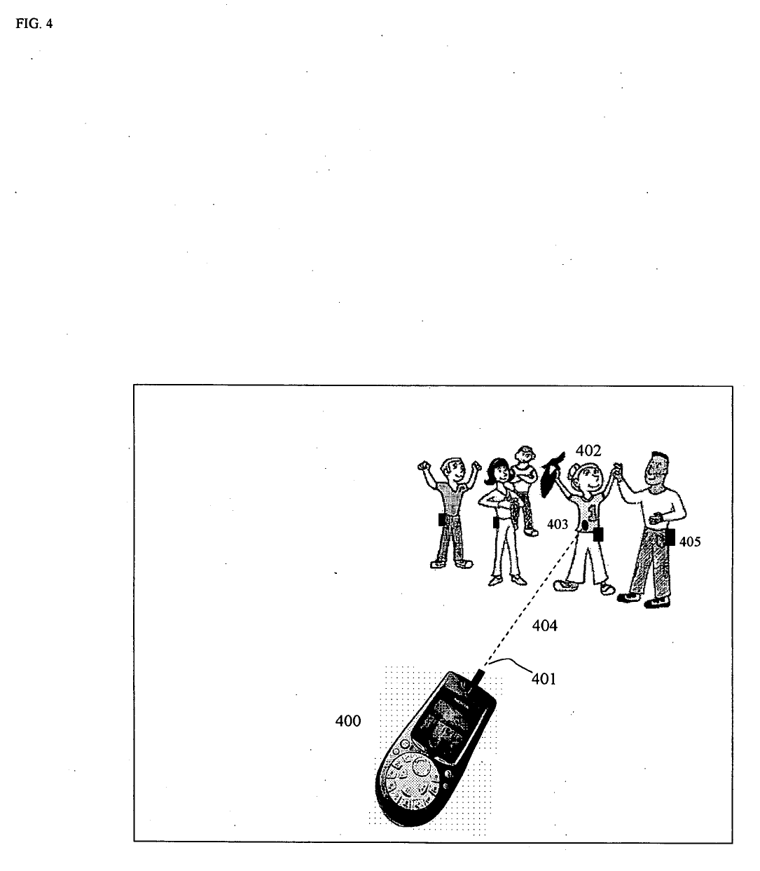

The basic operation is shown in FIGS. 3 and 4. In particular, the method enables portable computing device users to access information about one another or initiate communication with one another, preferably on a permission basis, by a first of said users pointing their portable computing device (or a portion thereof) at a second of the users.

As illustrated in FIG. 3, when a first portable computing device users 302 targets a second portable computing device user 304 by aiming his portable computing device (or a portion thereof) at the current physical location of the second portable computing device user 304 at a current moment in time, the UTA server 300 determines whether the first user is authorized to access information about the second user (and which information is accessible) or determines whether the first user is authorized to initiate communication with the second user. The determination is based upon one or more factors. One of the factors is whether or not the first user requested information access, communication initiation, or both, with the second user (as indicated by how the first user interacted with the interface of his portable computing device while performing the targeting operation). Another of the factors is the first user successfully targeting the second user by pointing at his or her current physical location as determined by the UTA server which receives location information about a group of users and stored them in a tracking database. Other factors are based upon personal profile information, access-preference information, or social networking information stored for the first user, or the second user in a user information database. Other of the factors may also include the second user explicitly authorizing information access or communication initiation by responding in real-time to a prompt displayed upon his portable computing device. The prompt to the second user may include, for example, a visual or audio or tactile alarm imparted by the second user's portable computing device get the second user's attention as well as a visual or audio prompt indicating that another user has requested information access or requested communication initiation. The prompt may provide the first user's name, ID, handle, or other identifier. The prompt may also provide the second user with demographic information or social networking information about the first user. The prompt may also provide the second user with spatial information about the location of the first user relative to the second user. For example, a graphical map may be displayed that indicates the relative location of the first user with respect to the second user, depicting the relative distance and direction in which the first user currently resides.

As shown in FIG. 3, the UTA server 300 is operative to send and receive data from a group of portable computing devices, each operated by a user. In the figure shown, the UTA server 300 is operative to send and receive data from a first portable computing device 302 operated by a first user as well as send and receive data from a second portable computing device 304 operated by a second user. The data received by the UTA server from each portable computing device includes but is not limited to current positional coordinates for each of the portable computing devices, the positional coordinates describing or otherwise indicating the substantially current geographic location of each portable computing device. Because it is assumed that the portable computing devices are kept local to its user (i.e. held, worn, or otherwise carried about by a user), the positional coordinates are also assumed to describe or otherwise indicate the substantially current geographic location of each of the users.

The UTA server 300 as shown in FIG. 3 is also operative to determine if one or more of the group of portable computing devices, as operated by its user, targets one or more other of the group of portable computing devices by virtue of being aimed at the geographic location of that one or more other of the group of portable computing devices while its user engages an appropriate user interface function. As shown specifically in the figure, the UTA server is operative, for example, to determine if a first portable computing device 302 as controlled by a first user targets the physical location of a second user using a second portable computing device 304. The UTA server is further operative to determine if the first user is authorized to access information about the second user or if the first user is authorized to initiate communication with the second user. The UTA server is further operative to moderate the subsequent information exchange between users or the subsequent communication initiation between users if such exchange or communication is authorized.

This process of determining if a first user successfully targets a second user and further determining if the first user is authorized to access information about and/or initiate communication with the second user is referred to herein as a targeting determination. The UTA server 300 makes the targeting determination based upon a number of computational steps. In one example embodiment, the procedure follows four basic operational steps.

The first step is the transmission of current positional coordinates from each of a group of portable computing devices to the UTA server, the current positional coordinates representing the then current geographic location of each of the portable computing devices. The current positional coordinates are stored by the UTA server in accessible memory and indexed such that each current positional coordinate is linked to the specific portable computing device or specific user from which it was received. By current geographic location it is understood that there will generally be some amount time lag that causes the most currently received and stored location for a particular user of the portable computing device to actually reflect a location of that user of the portable computing device at a recent time in the past. It is therefore desirable for the current embodiment to keep such time lags as small as possible within the practical limitations of the technology employed. This means frequent updates of current positional coordinates are sent from each portable computing device to the UTA server. In some embodiments this is achieved by having all portable computing devices update their location at a rapid rate such as 30 to 100 times per minute.

In other embodiments an intelligent algorithm is employed such that the update rate from each portable computing device is determined based upon the then current motion of that portable computing device. In such an algorithm, a portable computing device that is determined to be substantially at rest for a period of time will report infrequent updates of its location to the UTA server while a portable computing device that is determined to be in motion will report more frequent updates of its location the UTA server, the more rapid the motion of the portable computing device, the more frequent the reporting. In one such embodiment each portable computing device runs an Intelligent Reporting Algorithm upon a local processor, the Intelligent Reporting Algorithm accessing data from local positional and/or motion sensors and determines based upon such data if the portable computing device is in motion and if so the current rate of motion. For example, in one such embodiment the Intelligent Reporting Algorithm upon each portable computing device accesses data from GPS sensors local to each portable computing device at regular rapid intervals and computes based upon a time history of such data, a current velocity estimation for the portable computing device in one or more directions. The Intelligent Reporting Algorithm then determines a reporting rate of positional data to the UTA server based upon the current velocity estimation. If the velocity estimation is zero of low because a user is, for example, sitting or standing still—a slow reporting rate will be determined. For example, 1 report every two minutes. If the velocity estimation is high because the user is, for example, walking or running—a fast reporting rate will be determined. For example 100 to 400 reports per minute. By dynamically adjusting the reporting rate from each portable computing device based upon the currently estimated velocity of that portable computing device, this inventive method helps to better utilize available communication bandwidth, providing rapid reports from those user that require rapid reports for accurate tracking and infrequent reports from those users that do not require rapid reports for accurate tracking.

Some embodiments of the present invention enable each portable computing device to report its current velocity estimation to the UTA server along with its current positional coordinates during some or all updates. The velocity reports are used by the UTA server in such embodiments to account for time-lag by providing through an Predictive Tracking Algorithm in which a more accurate current location of a portable computing device is predicted based upon its reported current location (which is subject to time lag) and the reported velocity estimation associated with that reported current location. The Predictive Tracking Algorithm computes the more accurate current location of a portable computing device by adding a predictive spatial offset to the reported current location of that portable computing device, the predictive spatial offset being computed based upon the reported velocity estimation and the known or estimated time lag between the report and the current time. For example, if a portable computing device reports its current location as X,Y,Z in some units U. And if that portable computing device reports its current estimated velocity in units of U/sec to be Vₓ in the X direction, V_{y} in the Y direction and V_{z} in the Z direction. And if it is known (or estimated) that a (t) second time lag is present between the time when the data was collected and the current time the data is being processed by the UTA server, a more accurate current location can be predicted by adding an offset equal to the estimated current velocity V multiplied by known or estimated time lag (t) as follows: (X+Vₓ t), (Y+V_{y} t), (Z+V_{z} t).

To support accurate time lag computations or estimations, some embodiments of the present invention enable portable computing devices to also report a time-stamp value to the UTA server along with the report of current positional coordinates. The time-stamp value indicates or otherwise represents the time at which the current positional coordinate was collected. This value is then used by the UTA sever to determine the time lag between when the most recently current positional coordinate was reported from a given portable computing device and the then current time at which targeting computations are being performed. In this way the UTA server can know how up to date each positional coordinate is when performing a targeting determination. In this way the UTA server can also more effectively account for time-lag using a predictive algorithm such as the one described above.

Thus, some embodiments of the present invention are configured such that each portable computing device reports to the UTA server its most current positional coordinates, its most current velocity estimation, a time-stamp indicating when the positional coordinates were collected, and unique identifier enabling the UTA server to correlated the received data with a particular portable computing device and/or particular user. Some or all of this data is then stored in a tracking database for the plurality of users. In some embodiments in which the portable computing device does not report a time stamp, the UTA server may be configured to store it's own time-stamp for data received, the UTA server time-stamp indicating the time at which a current positional coordinate was received from a particular portable computing device. Such a time-stamp is generally not as accurate as one generated by a portable computing device itself for there may be communication and processing delay that is not accounted for, but using this method reduces the amount of information that need be communicated over the communication link and therefore helps preserve communication bandwidth.

In some embodiments of the present invention the UTA server also stores a time-history of current geographic locations for said plurality of users, said time-history reflecting one or more previous but recent locations of each of said plurality of users. Furthermore, in some embodiments of the present invention the UTA application running on the UTA server may be operative to predict a current location of a user based at least in part upon the stored time-history of previous locations of that user, for example by deriving a velocity from the stored time-history of previous locations of that user and computing an offset based upon the derived velocity and a known or estimated time lag. For example, if the UTA server receives a current location from a portable computing device as X,Y,Z in some units U. And if the UTA server computes an estimated current velocity for that portable computing device based upon a time-history of stored location data for that portable computing device. And if the estimated current velocity (V) in units of U/sec are determined to be Vₓ in the X direction, V_{y} in the Y direction and V_{z} in the Z direction. And if it is known (or estimated) that a (t) second time lag is present between the time when the data was collected and the current time the data is being processed by the UTA server, a more accurate current location can be predicted by adding an offset equal to the estimated current velocity V multiplied by the time lag (t) as follows: (X+Vₓ t), (Y+V_{y} t), (Z+V_{z} t).

Thus in first step of the targeting determination process, there are a variety of ways in which the UTA server may receive and store positional data from each portable computing device in a tracking database, the positional data including current positional coordinates for that portable computing device and optionally including velocity data and/or time-stamp data and/or historical data for that portable computing device. This step is repeatedly performed at a rapid rate such that said UTA server receives repeatedly updated and substantially current data about the location of said plurality of portable computing devices.

The second, third, and forth operational steps of the present embodiment of the invention are related to the specific targeting operation performed by a first user when seeking to gain information about and/or initiate communication with one or more other users (in this example, the second user). These steps are generally performed in response to a user targeting another user using his portable computing device. The first user initiates the targeting operation by aiming his or her portable computing device (or a portion thereof) at the then current visible location of the second user while engaging a user interface option upon his or her portable computing device.

The second step is the reading of position and orientation sensors local to a portable computing device of the first user in response to that user initiating a targeting operation, the position and orientation sensors including for example a GPS sensor and other orientation sensors such as an accelerometer or magnetometer. The reading of the sensors provides a positional coordinate and orientation direction for the portable computing device as positioned by the user. In one preferred embodiment the portable computing device is a handheld unit that can be freely aimed by the user at a targeted user. A variety of aiming tools and methods may be employed such as a laser pointer or a displayed image from a digital camera with overlaid crosshairs. When the portable computing device is aimed at a target user or a group of target users, the user presses a button, performs a gesture, utters a word or phrase, or otherwise indicates to the local system that the device is aimed at one or more targeted users. Based upon the button press or other indication by the user that the device is aimed as desired, the software running upon the portable computing device reads said position and orientation sensors to determine current positional coordinates and current orientation vector for said portable computing device.

The third step is the determination of targeting vector(s), targeting distance(s) or targeting coordinate(s) for a specific target user or group of target users as defined by the aiming of the portable computing device by the first user. The targeting itself is likely performed by the first user using one or more inventive targeting tools or targeting methods. A targeting vector is determined as an angular vector originating at the current positional coordinates of the first user and pointing in the direction that the portable computing device was aimed during targeting. A targeting distance is determined as a distance away from the current positional coordinates of the first user that a target user is positioned. A targeting coordinate is a spatial coordinate representing the targeted location of a target user as determined by adding an offset to the current positional coordinates of the first user, the offset being in a direction defined by a targeting vector and of a distance defined by a targeting distance. In some embodiments of the present invention, one or more range values is also determined for each targeting operation, the range values including one or more of an angular range value or a distance range value. An angular range value defines a range of acceptable angles around a targeting vector, for example ±5 degrees, within which a targeted user may reside. A distance range value is a range of acceptable distances around a targeting coordinate, for example ±10 feet, within which a targeted user may reside. In some embodiments a plurality of range values may be computed for a plurality of different directions, including for example a minimum value and a maximum value. Finally it should be noted that a plurality of targeting vectors, targeting distances or target coordinates may be determined during a particular targeting operation if a plurality of users are identified by the first user.

The forth step is a determination by the UTA server based upon said targeting vector(s), targeting distance(s) or targeting coordinate(s), which users are being targeted and whether or not the first user can access information about the targeted user(s) or initiate communication with the targeted user(s). The forth step has a number of sub-steps.

In sub-step (A) the UTA server identifies each of the targeted user(s) based upon their current geographic location as stored within the tracking database. This identification step may follow a number of different computational processes. In one computational process the UTA server computes an offset from the current positional of the first user in the direction of a targeting vector and determines the one or more users who reside on or near the line defined by the targeting vector. In an alternate computational process the UTA server computes an offset from the current positional of the first user along the direction of a targeting vector and determines the one or more users who reside within an angular targeting range around the targeting vector. In an alternate computational process the process the UTA server computes an offset from the current positional of the first user along the direction of a targeting vector and determines the one or more users who reside on or near the line defined by the targeting vector AND who are nearest in absolute spatial distance from the first user. In an alternate computational process the UTA server computes an offset from the current positional of the first user along the direction of a targeting vector by a distance equal to a targeting distance and determines the one or more users who reside on or near the point defined by the offset. In an alternate computational process the UTA server computes an offset from the current positional of the first user along the direction of a targeting vector by a distance equal to a targeting distance and determines the one or more users who reside within a targeting range of the point defined by the offset.

In sub-step (B) the UTA server accesses information about each of the target users determined in sub-step (A), the information including for example personal profile information, social networking information, or access preference information. The UTA server also accesses information about the first user, the information including for example personal profile information, social networking information, and/or access preference information.

In sub-step (C) the UTA server determines based upon the information accessed in sub-step (B) whether or not the first user is authorized to access information about one or more of the targeted users and/or whether or not the first user is authorized to initiate communication with one or more of the targeted users. This determination is also dependent upon whether or not the first user requested information about one or more targeted users, requested communication initiation with one or more targeted users, or both. This determination may also be dependent upon one or more targeted users granting permission. In such embodiments that require permission of one or more targeted users, the UTA server communicates with each of such targeted users and causes their portable computing device to alert them (by visual, audio, or tactile alarm) and prompt them to grant or deny permission. In many such embodiments the UTA server also communicates certain information about the first user to each of such targeted users such that their portable computing device can display said certain information for their use in granting or denying permission. For example, the UTA server may be configured to communicate demographic data such as the age, gender, school affiliation, company affiliation, political party information, and/or marital status to each of such targeted users. Such information is displayed to each of such targeted users by their respective portable computing device such that they can consider such information when granting or denying permission. Similarly, the UTA server may be configured to communicate social networking data that describe one or more friendship relationships or business relationships of the first user to each of such targeted users. Such information is displayed to each of such targeted users by their respective portable computing device such that they can consider such information when granting or denying permission. Similarly, the UTA server may be configured to communicate peer-rating data for the first to each of such targeted users. Peer rating data is data about the first user that has been compiled based upon input from other users as a result of previous interactions between the first user and other users as moderated by the UTA server. This information reflects the satisfaction and/or dissatisfaction that other users expressed as a result of such previous interactions. Such peer-rating information is displayed to each of such targeted users by their respective portable computing device such that they can consider such information when granting or denying permission. Similarly, the UTA server may be configured to communicate user popularity data for the first to each of such targeted users. User popularity data is data about the first user that has been compiled based upon the number of previous interactions between the first user and other users as moderated by the UTA server. This information reflects the number of times the first user has had other unique users access information about him or her and/or the number of times the first user has had other unique users initiate communication with him or her. Such user popularity information is displayed to each of such targeted users by their respective portable computing device such that they can consider such information when granting or denying permission.

If it is determined in sub-step (C.) that the first user is authorized to access information about one or more of the targeted users, in sub-step (D) the authorized information is accessed by the UTA server and transmitted to the portable computing device of the first user over a communication link. In sub-step (D) may include a selection process in which the first user selects desired information from among a plurality of accessible information types or categories. If it is determined that the first user is authorized to initiate communication with one or more targeted users, the UTA server enables communication initiation with the one or more targeted users. This may be achieved by the UTA server routing a communication message or communication request from the first user to each of the targeted users with whom communication initiation is authorized. Alternately this may be achieved by sending communication authorization data or communication routing data to the first user enabling the first user to communicate directly with authorized targeted users without being routed through the UTA server. In some embodiments this is achieved in whole or in part by the UTA server sending a phone number, email address, instant messaging address, alias, or other unique identifier about each of the authorized targeted users to the first user so that the first user can initiate communication with one or more of the authorized targeted users. This step may include a selection process in which the first user selects from among a plurality of targeted users, which user or users he or she desires to initiate communication with. In some such embodiments the first user receives information about a plurality of targeted users, the information including for example personal profile information and/or social networking information and is provided the ability to review some or all of such information on this display of his or her portable computing device. Based upon such a review, the first user is enabled a selection process by which he or she, based upon the review of information about each of a plurality of targeted users, selects which of the plurality of users the first uses wants to initiate communication with.

In many embodiments of the present invention, a portable computing device user when targeted by another user who requests communication initiation, may accept or decline the communication by interacting with the user interface upon his or her portable computing device. In many embodiments the UTA server moderates the communication initiation be transmitting messages to the users that masks personally identifying information thereby preserving user anonymity.

With respect to user registration, a portable computing device user registers for the service provided by an embodiment of the present invention. Typically the user is prompted to fill database fields providing personal or professional details including: age, gender, marital status, interests, highest level of education, school affiliation, team affiliation, political party affiliations, hobbies, business affiliation, job description, industry of employment, management hierarchy level, music preferences, sports team preferences, country of residence, city of residence, state of residence, city of birth, state of birth, or country of birth. The user also outlines the profile or characteristics of people the user would like to interact with through the service or people the user would not like to interact with through the service.

Targeting Methods and Apparatus

An important aspect an embodiment of the present invention is the ability of a user of a portable computing device to target a user (or group of users) that they are looking at in the distance and gain information about that user (or group of users) or initiate communication with that user (or group of users) by pointing. The hardware employed by the current invention to enable such person-to-person pointing-based interactions incorporates position sensor technology such as GPS that tracks the geographic location of said portable computing device as carried about by each of said users. The hardware employed by an embodiment of the current invention incorporates orientation sensor technologies such magnetometers and accelerometers that track the orientation of said portable computing device, the orientation indicating the direction that the portable computing device (or a portion thereof) is pointing as held by the user. The magnetometer and accelerometers can determine the spatial orientation with respect to magnetic north as well as the spatial orientation with respect to the downward direction due to gravity. The software running upon the portable computing device can determine not only where the user is in the world (based upon position data collected by said GPS sensors) at particular points in time, but also what direction the user is pointing at (based upon orientation sensor data) as the user manipulates the portable computing device (or a portion thereof) and aims it at a desired remote target. This action by the user of aiming the portable computing device (or a portion thereof) at a particular user (or group of users) is referred to as “Targeting” and involves the user pressing a button or otherwise manipulating a user interface to indicate that the portable computing device is then aimed at a desired target user (or group of users). As also described herein, the user can define the Target User Type which is the type of object about which the user is searching for information, for example: male, female, student, doctor, police officer, etc.

To support an embodiment of the present invention, there remains a need for additional methods and apparatus to enable a user to accurately aim the portable computing device (or a portion thereof) at a particular user (or group of users) and press a button (or otherwise manipulate said user interface) to indicate that the portable computing device is then aimed at a particular user about whom information should be accessed or with whom communication should be initiated. This is because it may be difficult for a user to know with a high degree of accuracy how well he or she is aiming said portable computing device (or a portion thereof) at a particular user (or group of users) that is some distance away from where the user is standing. In addition there may be many potential target users in close proximity, only one of some of whom a user desires to target. To satisfy this need, a number of inventive methods and apparatus have been developed that facilitate targeting. These methods are described on the pages to follow with respect to one particular type of embodiment—a portable computing device that is a handheld unit that can be aimed at a remote location by the user. That said, the same methods can be implemented in other physical embodiments, including but not limited to wrist worn embodiments and head mounted embodiments. Also, some embodiments may employ multiple targeting tools that can be used simultaneously or can be selectively switched between. These methods are described in detail in the paragraphs below:

Method 1: Passive Laser Pointer:

This method enhances a user's ability to target a remote user (or one bounding edge of a group of user) by aiming a laser pointer at the desired target. This inventive method includes a laser pointer within the casing of the portable computing device such that when the portable computing device is held in the hand of the user and aimed at a remote target, the laser pointer shines in the aiming direction and illuminates the currently aimed target with a characteristic laser dot. A button or other user manipulatable interface is included upon the portable computing device such that the user can selectively activate the laser pointer. When the laser pointer is activated, the user can see an illuminated dot indicating where the portable computing device is then currently aimed. This illuminated dot serves as a highly valuable reference for the user such that the user can move the portable computing device around in his hand, changing its orientation in space, until the illuminated dot is shining upon the desired target. The user can then press another button (or otherwise interact with the user interface of the portable computer system) to indicate that the desired aiming has been achieved. The portable computing device then reads the position sensors and orientation sensors (and optionally the ranging sensors or ranging user input controls) to determine the remote location and/or the range of remote locations that is being targeted by the user at that time.

In some embodiments this is a multi-step operation wherein the user targets the bounding edges of a group of users by targeting multiple times at each desired a boundary point.

As shown in FIG. 4, a handheld portable computing device (400) is equipped with a GPS sensor for tracking its position and one or more orientation sensors for tracking the direction that the handheld portable computing device is aimed by the user who is holding it (not shown). Also included and shown in the figure as element (401) is an integrated laser pointer for projecting a red dot (403) upon distant users that fall within the line-of-sight aiming direction of the portable computing device. The laser beam is represented by dotted line (404) and projects as a straight line along the direction of aiming. In this figure the user aims the portable computing device at one of five distant users that are visible to the user, using the laser pointer to aid in the aiming process. As shown in the figure, these five distant users are members of a social networking service. Each has their own portable computing device local to their person. In the figure, each of their portable computing devices is worn on their waist and represented by the drawn black rectangle. One of such portable computing devices is shown as 405 in the figure. Each of these portable computing devices includes a position tracking sensor. In this example the position tracking sensor local to each portable computing device is a GPS transducer integrated within the casing of each portable computing device. Each portable computing device is operative to detect its current position at regular intervals (by accessing the GPS transducer) and reports a representation of its current position to the UTA server following the methods described previously. In some embodiments each portable computing device is operative to also report a time-stamp, a velocity, or a unique user identifier to the UTA server along with the representation of its the current position. The UTA server stores the received information in a tracking database that is indexed such each received position coordinate is correlated with the user or portable computing device from which it was received.

As further shown in FIG. 4, the user of the targeting portable computing device 400 (that user not shown), aims the portable computing device at a desired target user. By watching the location of the red dot 403 the targeting user knows where he or she is aiming as he or she changes the orientation of portable computing device 400. Once the portable computing device is aimed at the desired target user 402 which is the forth person from the left in the figure, the targeting user presses a button (or otherwise engages the user interface on the portable computing device). This user-interface step may further include the targeting user, by pressing an appropriate button or otherwise interacting with the user interface, specifying if he or she desires information about the targeted user, desires to initiate communication with the targeted user, or both.

Upon taking such an action, the portable computing device 400 initiates a targeting determination process by following the computational steps outlined previously.

The first step of the targeting determination process involves portable computing device 400 reading data from a positional sensor such as a GPS sensor at the moment in time when the targeting user pressed the button or otherwise indicated through the user interface that the portable computing device (or a portion thereof) was properly aimed at the targeted user.

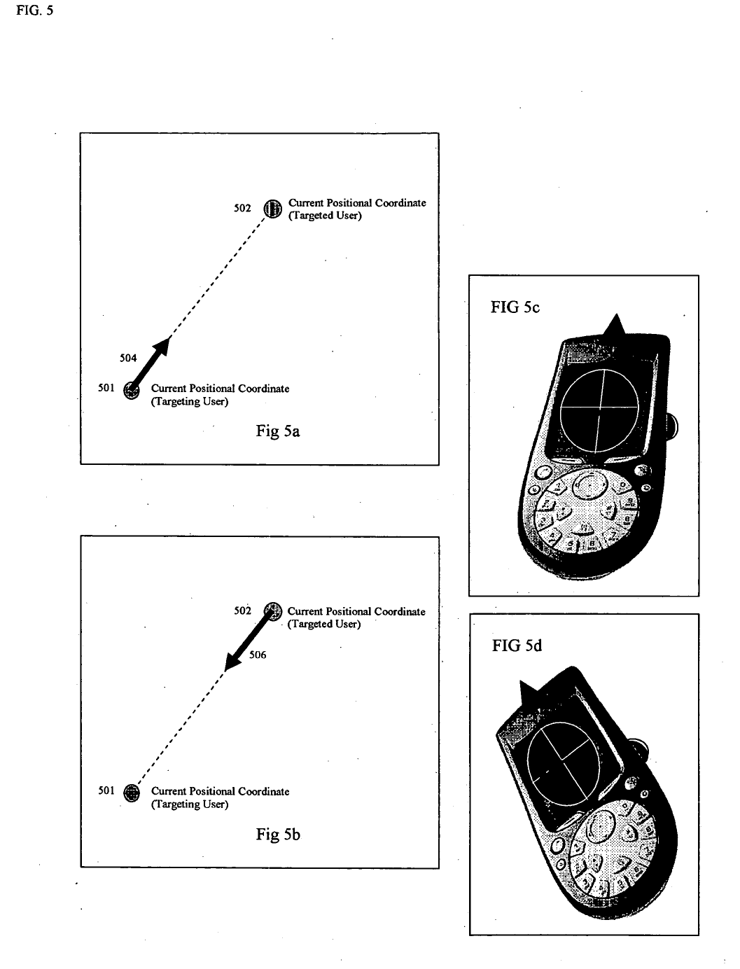

As shown in FIG. 5a as a shaded circle, this sensor reading is performed to derive a current positional coordinate for the targeting user, for example the coordinate 501. Also shown schematically in the figure is the then current location of the targeted user 502 as another shaded circle. The first step of the targeting determination process further involves the portable computing device 400 reading data from one or more orientation sensors such as a magnetometer or accelerometer at the moment in time when the targeting user pressed the button or otherwise indicated through the user interface that the portable computing device was properly aimed at the targeted user. This sensor reading is performed to derive a targeting vector for the targeting user that points in the direction from the targeting user to the targeted user, for example the vector 504 shown schematically in FIG. 5a as an arrow. The first step may also further involve the portable computing device reading data from a ranging sensor and/or from a ranging user interface element to derive and/or estimate a distance from the targeting user to the targeted user. In some embodiments of the present invention, one or more range values is also determined for each targeting operation, the range values including one or more of an angular range value or a distance range value.

Once the current positional coordinates 501 are determined for the targeting user and a targeting vector 504, targeting distance, target coordinates, and/or range values are derived and/or determined for the current targeting operation, these values are sent from the portable computing device 400 to the UTA server over a communication link. The UTA server then uses this information to determine which user(s) are being targeted by the targeting user and whether or not the targeting user can access information about the targeted user(s) or initiate communication with the targeted user(s). The sub-steps involved in this determination were described in detail previously in this document.

If it is determined by the targeting determination process that the targeting user has successfully identified the targeted user through the aiming process and that the targeting user is authorized to access information about the targeted user, the authorized information is accessed by the UTA server and transmitted to the portable computing device 400 over a communication link. This information is then displayed to the targeting user on the visual and/or audio display of portable computing device 400. If it is determined by the targeting determination process that the targeting user has successfully identified the targeted user through the aiming process and is authorized to initiate communication with the targeted user, the UTA server is further operative to moderate the subsequent communication, optionally maintaining the anonymity of the users involved.

In some embodiments, moderating the communication between the targeting user and the targeted user(s) is be achieved by the UTA server routing one or more communication message(s) between the targeting user to the targeted user(s). In many embodiments the UTA server transmits such messages while masking personally identifying information thereby preserving user anonymity of one or both users. In such embodiments a user may communicate for a period of time without the other user gaining access to that users phone number, email address, name, alias, or other person ID information that could be used to initiate communication in the future. In such embodiments such ID information is only communicated between users at their discretion based upon the initial communication experience.

In other embodiments, moderating communication between the targeting user and the targeted user(s) is achieved by sending communication authorization data and/or communication routing data to the targeting user enabling that user to communicate directly with the targeted user(s) without being routed through the UTA server. In some such embodiments this is achieved in whole or in part by the UTA server sending a phone number, email address, instant messaging address, alias, or other similar identifier about the targeted user to the targeting user so that the targeting user can initiate communication with the targeted user.

In some embodiments of the present invention, the targeting determination process includes the UTA server sending a prompt to the portable computing device of targeted user 402 to inquire if that user explicitly approves or disapproves of the requested information access or communication initiation. This process generally causes an alarm (visual, audio, or tactile) to be initiated upon the portable computing device of user 402 to gain that user's attention. This process generally also includes a graphical or audio message being then displayed to targeted user 402, the message indicating that the user has been targeted for information access or communication initiation and that approval is required. In some embodiments the UTA server also sends information about the targeting user to the targeted user to facilitate the targeted users decision as to whether to approve of disapprove and/or the extent of approval. In some embodiments this information includes personal profile information, social networking information, peer-rating data, or user popularity data. The targeted user 402 then indicates his or her approval or disapproval or extent of approval by engaging the user interface of her portable computing device.

In some embodiments the UTA server may also communicate locative information to the targeted user indicating the relative location of the targeting user with respect to the targeted user. This information may be communicated as a user locative vector that points in the direction from the targeted user to the targeting user. Such a vector will generally be the same as the targeting vector derived and sent by the targeting user but will point in the opposite direction. Thus to derive the directional vector sent to the targeted user, the UTA server generally just inverts the direction of the targeting vector that was received or derived from information sent by the targeting user. If one or more of the users are in motion, an updated user locative vector may also be computed by the UTA server based upon an updated location of the targeting user and the targeted user. The updated user locative vector will be a vector with a direction that points from the targeted user to the targeting user and can be computed from the current positional coordinates of the targeting user and the current positional coordinates of the targeted user by using common vector mathematics know to the art. This updated user locative vector is computed repeatedly based upon the changing current positional coordinates of the users and is sent repeatedly to the targeted user.

FIG. 5b shows a schematic representation of the spatial coordinates of the targeting user 501 and the targeted user 502. It must be noted that the UTA server, having identified the targeted user through the targeting determination process, now has access to the current positional coordinates of both users as received and stored in the tracking database. Using such coordinates, the UTA server can derive a user locative vector that points in the direction from the targeted use to the targeting user by using common vector mathematics know to the art. This user locative vector is shown schematically as arrow 506 in the figure. If one or more of the users are in motion, this vector is repeatedly computed by the UTA server based upon the updated positional coordinates for the two users. The user locative vector is sent to the portable computing device of the targeted user by the UTA server each time it is computed.

Upon receiving the user locative vector from the UTA server, the portable computing device of the targeted user 402 may optionally display a graphical indication allowing the targeted user to visualize the direction from which he or she was targeted. This can be a graphical line or arrow that indicates the direction which the targeted user should look to see the targeting user. To draw such a graphical line or arrow, the portable computing device of the targeted user needs to perform a number of steps.

First the portable computing device receives the user locative vector from the UTA server. Second the portable computing device reads data from one or more orientation sensors such as a magnetometer or accelerometer within or upon the portable computing device. This sensor reading is performed to derive a current orientation vector for the portable computing device indicating the direction in which the user is currently holding the device. Using these two vectors, a current orientation vector that indicates the direction the targeted user is holding the portable computing device and the user locative vector that indicates the direction of the targeting user, the portable computing device can derive the direction in which a graphical line, arrow, or other indicator should be drawn upon the display of the portable computing device allowing that user to visualize the direction of the targeting user. Such a process is performed by using the current orientation vector as a spatial reference and then drawing the user locative vector relative to the current orientation vector.

As shown in FIG. 5C an orientation vector would be drawn upon the display of the portable computing device of the targeted user. As shown in FIG. 5C an arrow is drawn upon the display of the portable computing device of the targeted user, the arrow pointing in the spatial direction of the current location of the targeting user. In this way the targeted user can turn and look and likely identify the targeting user. As the targeted user turns his body and thereby changes the current orientation of his or her portable computing device, the current orientation vector changes for the portable computing device. Using updated current orientation vector data, the portable computing device redraws the arrow such that it continues to point in the direction of the current location of the targeting user by accounting for the changed orientation of the targeted user's portable computing device. And example of a redrawn arrow as it might be displayed upon the portable computing device of the targeted user after the targeted user changed the orientation of his or her portable computing device is shown in FIG. 5d. As is seen by comparing FIG. 5c and FIG. 5d, the arrow changes its relative orientation as displayed upon the screen of the portable computing device such that it continues to point in the absolute direction of the targeting user.

Referring back to FIG. 4 which shows a laser pointer based targeting tool, it must be noted that the portable computing device of the targeting user includes a user interface button or other manipulatable interface for turning on the laser pointer at desired times. The user will use this button to turn on the laser pointer only when he or she desires aid in aiming the portable computing device at a desired target. It should also be noted that in many cases the size of the target area is substantially larger than the size of the laser dot displayed by the targeting aid. In some embodiments the targeting aid can also depict the size of the targeting area by displaying multiple dots or other projected images.

Method 2: Digital Camera with Display

This method enhances a user's ability to target a remote user (or group of users) by including a digital video camera within the casing of the portable computing device such that when the portable computing device is held in the hand of the user and aimed at a remote location, the camera captures an image in the in the aiming direction, the image being displayed upon the screen of the portable computing device, the image depicting that part of the real physical space which is being aimed at by the user. In some embodiments everything that is displayed upon the screen falls within the range of remote locations being aimed at within the real physical space. In other embodiments, a point (or area) on the image at the center of the screen (or near the center) is that location that is being aimed at in the real physical space. In such embodiments graphical crosshairs can be optionally overlaid upon the displayed image to indicate the point on the image that is being aimed at within the real physical space. In other embodiments a particular area of the image on the screen is the area of locations that is being aimed at in the real physical space. In such embodiments a graphical image depicting the selection area (such as a box or a circle or a shaded region) may be optionally overlaid upon the displayed image to indicate the area on the image that is being aimed at within the real physical space.

The size of said selection area (for example the size of said box or circle or shaded region) can be optionally controlled by the user through the user interface on the portable computing device. By changing said size of the selection area, the user can change the size of the target area for which user-information or user-communication initiation is requested. For example if the user sets the size of the area to be large, a large angular range and/or distance range is defined and sent with the targeting vector or targeting coordinate to the UTA server when targeting a remote user (or group of users). On the other hand, if the user sets the size of the area to be small, a small angular range or distance range is defined and sent to the UTA server part of the targeting process. In this way, if the user sets the size of the selection area to be large, the software on the UTA server targets users within a larger area than if the user sets the size of the selection area to be small.

A button or other user manipulatable interface is included upon the portable computing device such that the user can selectively activate the digital camera such that the image of the targeted area currently being aimed at is displayed. This displayed image serves as a valuable reference for the user such that the user can move the portable computing device around in his hand, changing its orientation in space, until said image includes the desired target user(s). The user can then press another button (or otherwise interact with the user interface of the portable computer system) to indicate that the desired aiming has been achieved. The portable computing device then reads the position sensors and orientation sensors (and optionally the ranging sensors or ranging user input controls) to determine the targeting vector, targeting coordinates, or range values for the current targeting action. These values are sent to the UTA server as described previously.

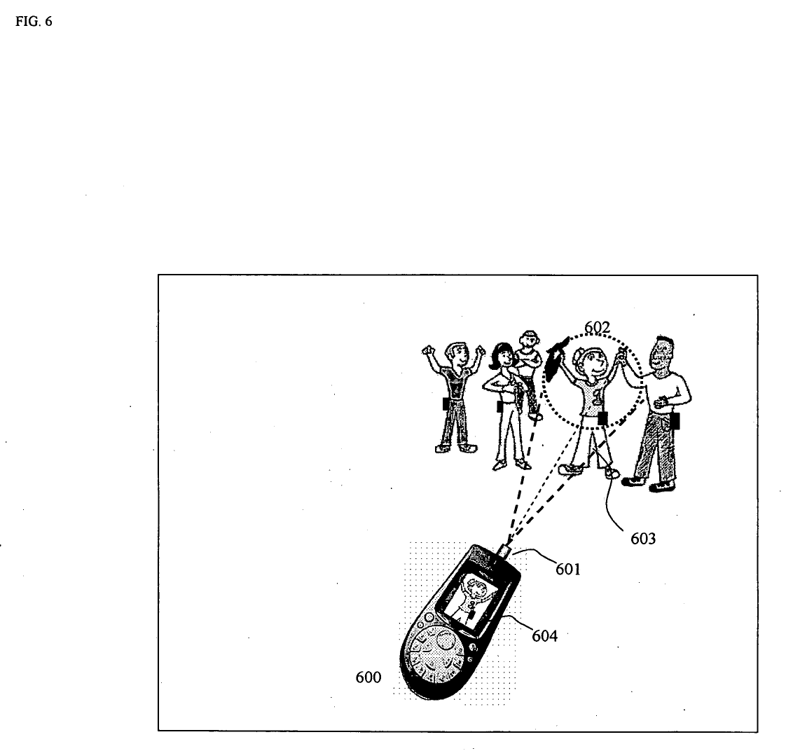

FIG. 6 shows a portable computing device equipped with a GPS sensor for tracking its position and one or more orientation sensors for tracking its direction as aimed by a user. Also shown is an integrated digital video camera 601 for capturing a line-of-sight image in the direction that the portable computing device is aimed by the user. The dotted lines 60) in the figure indicate the field of view of the camera as determined by the optics and how the portable computing device is aimed by the user. The captured image 604 is displayed upon the screen of said portable computing device showing the user what is being aimed at and thereby assisting in the targeting process. Cross hairs or other graphics (not shown) may be overlaid upon the displayed image to assist the user in accurate targeting. In this figure the user aims the portable computing device at one of five users that are visible to the targeting user, using the displayed image captured by said camera to aid in the aiming process. By watching the displayed image the targeting user knows where he is aiming the portable computing device as he or she changes the orientation. Once the portable computing device is aimed at the desired target 602 which is the forth person from the left in the figure, the user presses a button (or otherwise engages the user interface on the portable computing device) to either (a) request information about that person, (b) request communication initiation with that person, or (c) both request information about that person and request communication initiation with that person. Upon engaging the user interface as such, the portable computing device of the targeting user is operative to communicate targeting information to the UTA server as described previously, the targeting information including the current positional coordinates of the portable computing device as well as a targeting vector, targeting distance, or targeting coordinate that reflects how the portable computing device was being aimed at the moment the user interface was engaged indicating that the target was being aimed. The portable computing device may also send an angular range, or distance range to the UTA server indicating a range of acceptable values around the current aiming direction or location. The portable computing device may also send a time-stamp indicating the specific moment in time at which the targeting was performed.

Once the current positional coordinates of the targeting user are sent the UTA server along with a targeting vector, targeting distance, target coordinates, range values, and/or time-stamp values, that are used to represent the targeting location, the UTA server then uses this information to determine which user(s) are being targeted by the targeting user and whether or not the targeting user can access information about the targeted user(s) or initiate communication with the targeted user(s). The sub-steps involved in this determination were described in detail previously in this document.

If it is determined by the targeting determination process that the targeting user has successfully identified the targeted user through the aiming process and that the targeting user is authorized to access information about the targeted user, the authorized information is accessed by the UTA server and transmitted to the portable computing device 600 over a communication link. This information is then displayed to the targeting user on the visual or audio display of portable computing device 600. If it is determined by the targeting determination process that the targeting user is NOT authorized to access information about the targeted user, a message is displayed to the targeting user informing him or her that authorization was denied.

If it is determined by the targeting determination process that the targeting user has successfully identified the targeted user through the aiming process and is authorized to initiate communication with the targeted user, the UTA server is further operative to moderate the subsequent communication, optionally maintaining the anonymity of the users involved. If it is determined by the targeting determination process that the targeting user is NOT authorized to initiate communication with the targeted user, a message is displayed to the targeting user informing him or her that communication initiation was denied.

In some embodiments, moderating the communication between the targeting user and the targeted user(s) is be achieved by the UTA server routing one or more communication message(s) between the targeting user to the targeted user(s). In many embodiments the UTA server transmits such messages while masking personally identifying information thereby preserving user anonymity of one or both users. In such embodiments a user may communicate for without the other user gaining access to that user's phone number, email address, name, alias, or other person ID information that could be used to initiate communication again in the future. In other embodiments, moderating communication between the targeting user and the targeted user(s) is achieved by sending communication authorization data or communication routing data to the targeting user enabling that user to communicate directly with the targeted user(s) without being routed through the UTA server. In some such embodiments this is achieved in whole or in part by the UTA server sending a phone number, email address, instant messaging address, alias, or other similar identifier about the targeted user to the targeting user so that the targeting user can initiate communication with the targeted user.

In some embodiments the UTA server may also communicate locative information to the targeted user indicating the relative location of the targeting user with respect to the targeted user. This information may be communicated as a user locative vector that points in the direction from said targeted user to said targeting user. This process was described previously with respect to FIGS. 5a, 5n, 5c, and 5d.

An optical or digital zoom feature (not shown) can be employed within the digital camera embodiment described in the paragraphs above. Such an optical or digital zoom can allow the user to zoom-in or zoom-out with the camera and thereby change the field of view displayed upon the screen. By changing the displayed field of view by adjusting said optical or digital zoom, the user changes the range of distant location values or the range of targeting vector angles for which information is requested. For example if the user zooms out, a large range of values are sent to the UTA server as part of the targeting process. But if the user zooms-in, a small range of values are sent to the UTA server as part of the targeting process. Said another way, if the user zooms-out, the software targets users within a larger spatial area than if the user zooms-in.

A manual or automatic focus mechanism (not shown) can be employed within the digital camera embodiment described in the paragraphs above. Such a manual or automatic focus mechanism can be used along with the zoom function to determine or estimate range information to a remote target location. In one embodiment the user can manually twist a lens to bring an object into focus. A sensor mounted upon the lens adjustment mechanism, such as an optical encoder, detects the position of the lens or lenses within the focus mechanism. The portable computing device processor, by reading said sensor, can determine or estimate the distance or range of distances to the location that is then currently in focus. In this way a user's manual adjustment of an optical focusing mechanism can be used to provide ranging information to a desired distant user (or group of users). In other embodiments an electromechanical focus mechanism is used such that a user can press buttons or levers or knobs to electrically zoom and focus the lens mechanism. Such an embodiment also includes a sensor mounted upon the electromechanical lens adjustment mechanism, such as an optical encoder, detects the position of the lens or lenses within the focus mechanism. The portable computing device processor, by reading said sensor, can determine or estimate the distance or range of distances to the location that is then currently in focus. In this way a user's manual adjustment of an optical focusing mechanism can be used to provide ranging information to a desired distant user (or group of users). In many embodiments, such focusing mechanisms have a maximum focal length distance referred to generally as infinity. When the focus is set to infinity the user or computer processor must assume that the distance is greater than or equal to a set maximum focus ranging distance

Multiple Users That are Within or Near the Targeting Vector:

When the user aims the portable computing device in a particular direction, the targeting vector that is defined will extend indefinitely and thereby may point at multiple users who are on or near the targeting vector, many of which the targeting user is not interested in. For embodiments that do not include ranging hardware and therefore do not specify a target distance, it will not be clear which of the plurality of users the targeting user is intending to aim at. To address this problem, many embodiments of the present invention are configured such that when a plurality of users fall on or near the targeting vector (as determined by the UTA server during the targeting determination process), the UTA server selects the nearest distant user to the targeting user as the target user based upon the line of sight distance between the current positional coordinates of the targeting user and the current positional coordinates of the users being aimed at. In this way the UTA sever selects the distant user who is most nearest in the foreground as viewed by the targeting user when multiple distant users fall on or near the same targeting vector.

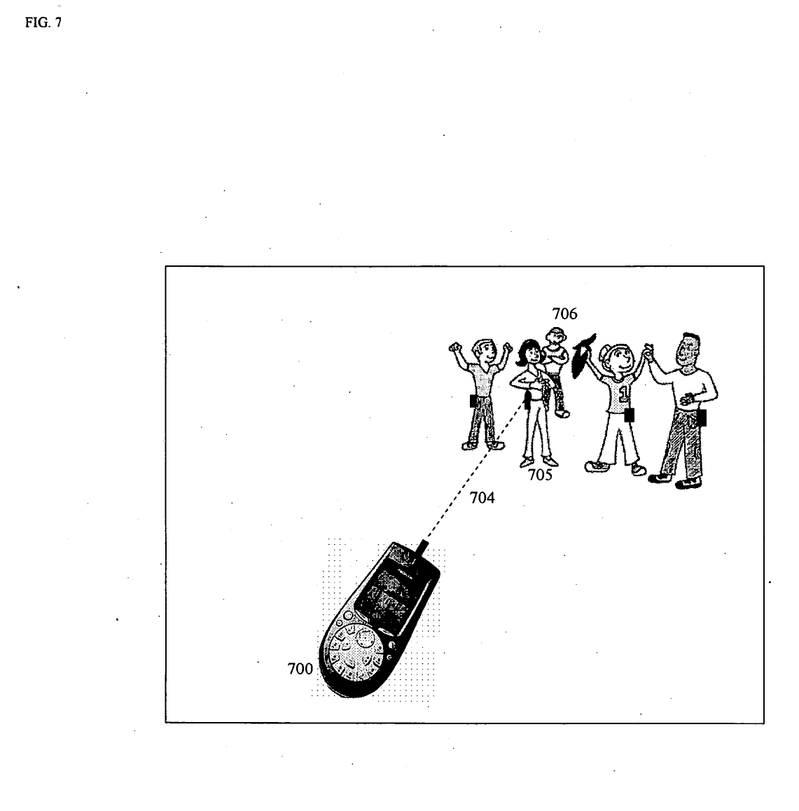

As shown in the FIG. 7, a portable computing device 700 is aimed by a targeting user in a particular direction. The resulting targeting vector is the direction depicted as dotted line 704. As shown in the figure, a plurality of users fall on or near the targeting vector, including user 705 and user 706. To deal with this ambiguity, the UTA server is configured as part of the targeting determination process, to identify the user who is nearest to the targeting user as the targeted user. This may be performed through simple vector mathematics. In one embodiment this is achieved using the current positional coordinates of the targeting user and the current positional coordinates of each of the distant users who fall within a certain range of the targeting vector and computing which of the distant users is nearest to the targeting user. In the figure shown, this is user 705 for she resides nearer to the targeting user than user 706 at the time of targeting. In this way ambiguity is resolved. This allows a user to target a distant user in a crowded area and know that the nearest distant user will be targeted.

Filtering Targets

To further specify which of a plurality of distant users a targeting user is aiming at, the targeting user may use his or her user interface to specify a TARGET USER TYPE as a means of more clearly specifying which type of user the user is trying to aim at within a crowded spaced. A defined herein, TARGET USER TYPE may include any piece of information that may be included in a users personal profile information and/or social networking information. For example, the TARGET USER TYPE may simply specify the intended gender of the targeted user. If the targeting user specified MALE as the TARGET USER TYPE, the UTA server would then perform the targeting determination process to select the nearest user of the plurality of users who fall on or near the targeting vector who is MALE as indicated by the stored personal profile information for that user. In this way, the targeting user in the example depicted in FIG. 7 could cause the UTA server to select use 706 and not user 705 as the targeted user. Thus the added parameter of a TARGET USER TYPE is helpful in allowing a targeting user to more clearly specify which user from among a plurality of users that user is trying to target.

Similarly a targeting user may point his or her portable computing device at a large crowd and set range values to encompass a large number of distant users. The targeting user may also set the TARGET USER TYPE to include social networking parameters that specify only users who are friends of the targeting user or friends-of-friends of the targeting user. In this way the user may quickly identify from among a large crowd of distant individuals which ones, if any, are friends or friends-of-friends.

Similarly a targeting user may point his or her portable computing device at a large crowd and set range values to encompass a large number of distant users. The targeting user may also set the TARGET USER TYPE to include personal profile parameters that specify only users who are students at a particular school. In this way the user may quickly identify from among a large crowd of distant individuals which ones, if any, are students of a particular school.

Similarly a targeting user may point his or her portable computing device at a large crowd and set range values to encompass a large number of distant users. The targeting user may also set the TARGET USER TYPE to include personal profile parameters that specify only users who are employees of a particular organization. In this way the user may quickly identify from among a large crowd of distant individuals which ones, if any, are employees of a particular organization.

Similarly a targeting user may point his or her portable computing device at a large crowd and set range values to encompass a large number of distant users. The targeting user may also set the TARGET USER TYPE to include personal profile parameters that specify only users who are a particular gender (for example FEMALE) and who fall within a particular age range (for example 25 to 35) and who have a political affiliation (for example members of the Democratic party). In this way the user may quickly identify from among a large crowd of distant individuals which ones, if any, are females between the ages of 25 to 35 who are democrats. In this way a particular combination of characteristics can be set by a targeting user when performing a targeting operation.

An additional tool that may be used for specifying which user from among a plurality of users who fall on or near a particular targeting vector is a manual roller such as the roller shown in FIG. 2. The targeting user may use the roller to scroll from near to far (or far to near) along the targeting vector, as a means of selecting users of increasing (or decreasing) distance from the targeting user along the targeting vector.

Demographic Scanning:

One application of an embodiment of the present invention that enables efficient information access about a large group of targeted users (as opposed to an individual targeted user or a small group of targeted users) that employs the same technical infrastructure as disclosed herein is known as Demographic Scanning.

In this feature a targeting user points his portable computing device in a particular direction and thereby specifies a particular area in the spatial environment that includes a large group of users about which he or she desires demographic information. For example, the user may point his or her portable computing device at the location of a particular bar or restaurant that the user is considering entering while walking down the street. Using the methods and apparatus as disclosed previously herein, targeting vector(s), targeting distance(s), targeting coordinate(s), angular range value(s), or distance range values(s) are sent from the portable computing device of the current user to the UTA server along with the current positional coordinates of that user. In this way the user specifies the geographic location or bounding area of the particular bar or restaurant about which he desires current demographic information. The user also specifies through the user interface of his or her portable computing device that he or she desires to receive a Demographic Scan about the specified location or area and may specify particular demographic characteristics that he or she is interested in. The UTA server then uses. accesses the tracking database, determines which users fall within the specified bounds, and tallies the users based upon each of the particular demographic characteristics. These demographic characteristics are then reported to the targeting user as a statistical profile. These demographic characteristics may include, for example, an indication of the gender makeup, age makeup, political party makeup, professional makeup, education level makeup, sports-team partiality makeup, marital status makeup, of the group of users within or near the specified area. In this way the targeting user may decide if this particular bar or restaurant is desirable to him or her. For example, the user may be looking for an establishment that has a high percentage or quantity of single women who have college degrees. Thus he can point at the establishment and request a demographic scan using the characteristics of gender, marital status, and highest level of education. The UTA server, in response to such a request, will report a statistical profile of target users based upon these characteristics. Alternately, the user may be looking for an establishment that has a high percentage of Mets fans. Thus he can point at the establishment and request a demographic scan using the characteristics of baseball team partiality. The UTA server, in response to such a request, will report a statistical profile of target users based upon these characteristics.

Alternately the user may be looking for an establishment that has a high percentage of people who are affiliated with a particular high-school, a particular hobby, or a particular profession. Thus he can point at the establishment and request a demographic scan using the characteristics of school affiliation, hobby, or profession. The UTA server, in response to such a request, will report a statistical profile of target users based upon one or more of these characteristics. In this way the demographic scanning feature of an embodiment of the present invention enables a user to gain insights about the demographic makeup of group of distant users.

Multi-Step Targeting:

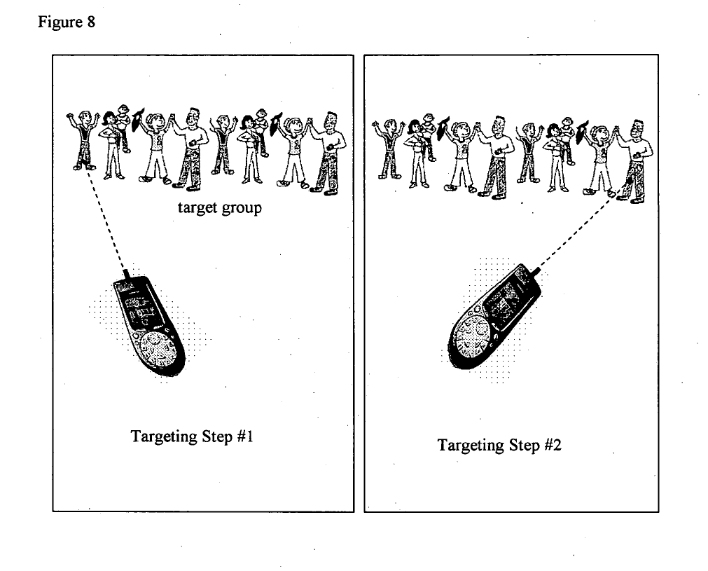

As described herein, a user may wish to define a group of users by specifying an area within which those users currently reside. This may be achieved in a variety of ways as described previously herein. One method, to be described in more detail with respect to FIG. 8, employs a multi-step targeting method in which the user specifies two targeting vectors that bound an angular targeting region. As shown on the left side of the figure, the targeting user of portable computing device points the portable computing device (or a portion thereof) at one edge of a bounding angular region and engages the user interface on the device to specify that first edge. Upon engaging the user interface, position and orientation data for the portable computing device are captured from sensors. As shown on the right side of the figure, the targeting user then points the portable computing device (or a portion thereof) at a second edge of a bounding angular region and engages the user interface on the device to specify that second edge. Upon engaging the user interface, position and orientation data for the portable computing device are captured from sensors. The portable computing device then sends data to the UTA server representing the first and the second edge. This data includes a current positional coordinate and targeting vector for each edge of the bounding region. This data may also include or targeting distance, a distance range, or a time stamp for each edge of the bounding region.

The UTA server then uses this data to determine which, if any uses currently reside within the area between the two bounding edges. As shown in the FIG. 8, this area includes ten users. The targeting user may also specify through the user interface of the portable computing device if he or she desires to gain information about this group of users, initiate communication with this group of users, or both. When gaining information about this group of users, the user may request that the information be presented as demographic statistics that indicate the demographic makeup of the group (with respect to specified criteria) as described with in the demographic scanning section above. For example, the targeting user may ask for demographic statistics about the gender makeup of the group by selecting appropriate choices upon the user interface menus of the portable computing device. The UTA server responds in accordance with such a request from the targeting user, computing and reporting that 40% of the targeted group is female and 60% of the targeted group is male. This data is presented to the targeting user upon the display of his or her portable computing device.

This invention has been described in detail with reference to preferred and alternate embodiments. It should be appreciated that the specific embodiments described above are merely illustrative of the principles underlying the inventive concept. It is therefore contemplated that various modifications of the disclosed embodiments will, without departing from the spirit and scope of the invention, be apparent to persons of ordinary skill in the art.

What is claimed is:

1. A system for pointing-initiated person to person communication, said communication system comprising:
A first portable computing device operated by a first user, said first portable computing device including a first location sensor, an orientation sensor; a user aiming portion, and a first wireless communication link to an user tracking application;
A plurality of second portable computing devices, said second portable computing devices each including a second location sensor and a second wireless communication link to the user tracking application;
Software routines running upon said user tracking application for determining if the aiming portion of said first portable computing device is aimed substantially at a particular second portable computing device as indicated by a representation of data from the first location sensor and orientation sensor as communicated over the first wireless communication link; and the spatial location of said particular second portable computing device as determined based upon data from a second location sensor of said particular second portable computing device as received by the user tracking application over a second wireless communication link;
Software routines running upon said user tracking application for enabling person to person communication between the user of said first portable computing device and the user of said particular second portable computing device in response to said determination.

2. The system of claim 1, wherein said location sensor includes a GPS transducer.

3. The system of claim 1, wherein said orientation sensor includes a magnetometer.

4. The system of claim 1 wherein said orientation sensor includes an accelerometer.

5. The system of claim 1, wherein said user tracking application maintains a database of substantially current location information for a plurality of portable computing devices.

6. The system of claim 1, wherein said user tracking application maintains a database of profile information for a plurality of portable computing devices.

7. The system of claim 1, wherein said user tracking application is operative to send profile information that is associated with said particular second portable computing device to said first portable computing device in response to said determination.

8. The system of claim 1, wherein said user tracking application is operative to send profile information that is associated with said first portable computing device to said particular second portable computing device in response to said determination.

9. The system of claim 1, wherein user input to said particular second portable computing device is used in determining if said communication is initiated.

10. The system of claim 1, wherein said software routines perform mathematical operations that determine if a vector extending from said spatial location of said first computing device and extending in the direction of said aiming portion is within a certain proximity of the spatial location of a second computing device.

11. The system of claim 10, wherein said software routines that determine if a vector extending from said spatial location of said first computing device and extending in the direction of said aiming portion comes closer to the spatial location of said particular second computing device than it does to a plurality of other second portable computing devices.

12. The system of claim 1, wherein said enabled person to person communication includes a voice conversation transmitted over a wireless network.

13. The system of claim 1, wherein said enabled person to person communication includes a text message transmitted over a wireless network.

14. A system of claim 13, wherein said text message is sent by said first computing device to said particular second computing device and is displayed upon a screen of said particular second computing device.

15. The system of claim 1, wherein said user aiming portion includes a camera for capturing a camera image in the aiming direction of the first portable computing device and wherein said first portable computing device includes a display for displaying the camera image.

16. The system of claim 15, wherein the second user of second portable computing device is selected by the first user in part by viewing the camera image on the first portable computing device.

17. The system of claim 1, wherein said first portable computing device includes a user interface element to be engaged by said first user when said aiming portion is desirably aimed, said communication being initiated at least in part in response to data received from said user interface element.

18. The system of claim 17, wherein said first portable computing device sends said aiming orientation data to said user tracking application in response to data received from said user interface element.

19. A method of providing person to person communication comprising:
determining the location and the pointing orientation of a first portable computing device proximately located to a first user;
determining the locations of a plurality of second portable computing devices proximately located to each of the second users in the pathway of the pointed orientation of the first portable computing device;
communicating a message from the first user of the first portable computing device to the plurality of second users operating the second portable computing devices.

20. A method as recited in claim 19, wherein the number of second portable computing devices is one.

21. A method as recited in claim 19 wherein said pathway is represented as one of a wedge shaped area or a cone shaped volume.

22. method as recited in claim 19 wherein said pathway is represented as one of a rectangular area or a cylindrical volume.

23. A method as recited in claim 21, further comprising determining if said second portable computing devices are located within the boundaries of said wedge shaped area or said cone shaped volume.

24. A method as recited in claim 22, further comprising determining if said second portable computing devices are located within the boundaries of said rectangular area or said cylindrical volume.

25. A method as recited in claim 19, wherein the communication with the second portable computing devices is manually initiated by the first user of the first portable computing device by engaging a user interface of said first portable computing device.

26. A method as recited in claim 25 wherein said manual initiation includes the pressing of a button or trigger upon said first portable computing device when said first portable computing device is desirably aimed.

27. A method as recited in claim 25, further comprising including a camera upon said first portable computing device, said camera aimed along said pointing orientation, the image from said camera being displayed upon a screen of said portable computing device so as to aid the first user in aiming said first portable computing device at said second users.

28. A method as recited in claim 19, wherein the initiation of communication with a second portable computing device is dependent at least in part upon the contents of personal profile data associated with said second portable computing device and/or with the user of said second portable computing device.

29. A method as recited in claim 19, wherein the initiation of communication with a second portable computing device is dependent at least in part upon the contents of personal profile data associated with said first portable computing device and/or with the user of said first portable computing device.

30. A method as recited in claim 19, wherein the initiation of communication with a second portable computing device is dependent at least in part upon a security setting associated with said second portable computing device and/or associated with the user of said second portable computing device.

31. A method as recited in claim 19, wherein the initiation of communication with a second portable computing device is dependent at least in part upon peer rating data associated with said first portable computing device and/or associated with the user of said first portable computing device.

32. A method as recited in claim 19, wherein the initiation of communication with a second portable computing device is dependent at least in part upon popularity data associated with said first portable computing device and/or associated with the user of said first portable computing device.

33. A method of gathering statistical information about a group comprising:
a first user pointing a first portable computing device towards a group of people with a plurality of second portable computing devices proximally located to each of the second users;
accessing the user profiles associated with a plurality of the second users of each of the second portable computing devices;
aggregating information for each of the user profiles obtained from each of the second portable computing devices;
displaying the aggregated information to the first user.

34. A method as recited in claim 33 wherein said accessing and said aggregating are performed by a server that is in communication with said first portable computing device and in communication with a plurality of said second portable computing devices, and wherein the resulting aggregated information is communicated from said server to said first portable computing device over a communication link.

35. A method as recited in claim 33 wherein the displayed information includes a statistical breakdown by gender.

36. A method as recited in claim 33 wherein the displayed information includes a statistical breakdown by age.

37. A method as recited in claim 33 wherein the displayed information includes a statistical breakdown by one or more organizational affiliations.

38. A method as recited in claim 33 wherein the displayed information includes a statistical breakdown by educational level and/or educational institution affiliation.

39. A method of tracking the location of a plurality of portable computing devices comprising: repeatedly receiving location data from each of said portable computing devices, storing the individual location coordinates of each portable computing device and creating a historical record of location coordinates, and estimating a current location of each of said plurality of portable computing devices based upon the most recent location data received from that portable computing device along with velocity data received from that portable computing device and/or velocity data derived from the historical record for that portable computing device.

40. A method as recited in claim 39 wherein said estimating is also based upon a time lag for each portable computing device, the time lag being substantially equal to the elapsed time between the current time and a time associated with the most recent location data received from that portable computing device.
